(19) United States
(12) Patent Application Publication
(10) Pub. No.: US 2022/0380571 A1
(43) Pub. Date: Dec. 1, 2022

(54) Filler mixture for chemical fastening systems and use thereof

(71) Applicant: Hilti Aktiengesellschaft, Schaan (LI)

(72) Inventors: Thomas BÜRGEL, Landsberg (DE); Vanessa SIRCH, Untermeitingen (DE)

(73) Assignee: Hilti Aktiengesellschaft, Schaan (LI)

(21) Appl. No.: 17/755,859

(22) PCT Filed: Nov. 30, 2020
(86) PCT No.: PCT/EP2020/083839

§ 371 Date: May 10, 2022

(30) Foreign Application Priority Data
Dec. 9, 2019 (EP) 19214397.2

(51) Int. Cl. C08K 3/36; C08K 3/30; C08K 3/22; C08K 3/26

(52) U.S. Cl. CPC C08K 3/36; C08K 3/30; C08K 3/22; C08K 3/26; C08K 2201/005; C08K 2003/3045; C08K 2003/2227; C08K 2003/265

(57) ABSTRACT

A hardener composition can be used for a reactive resin system containing a reactive resin based on radically curable, ethylenically unsaturated compounds. The hardener composition contains a hardener for the reactive resin and a filler mixture. The filler mixture is composed of a first filler having a first average particle size d_{50,1} and a second filler having a second average particle size d_{50,2}. The first average particle size d_{50,1} of the first filler is greater than the second average particle size d_{50,2} of the second filler (d_{50,1}>d_{50,2}). The ratio d_{50,1} to d_{50,2} (d_{50,1}:d_{50,2}) is in the range of 8:1 to 100:1. The filler mixture is useful, and a reaction resin system can contain the hardener composition.

The invention relates to highly filled hardener compositions for use in injection mortars for chemical fastening technology, in particular highly filled hardener compositions based on peroxides for resin compositions based on radically curable compounds.

Injection mortars based on radically curable compounds for chemical fastening technology are based on polymerizable resins that are generally cured using peroxides as radical formers, also referred to as hardeners. These products are formulated as multi-component, preferably two-component products and are packaged in multi-chamber, preferably two-chamber packages so as to prevent reactions.

Since the peroxide preferably used here, namely dibenzoyl peroxide, is a solid, it is necessary to bring said peroxide into a flowable form. According to the prior art, what are referred to as phlegmatizers are used for this purpose and to adjust the flowability and concentration of the radical former in the hardener composition or to adjust the volume of the hardener composition. These phlegmatizers act as a diluent and also avoid undesired decomposition of the radical formers. Various types of non-reactive plasticizers, for example dicarboxylic acid esters such as dioctyl phthalate, dioctyl adipate, liquid polyesters or polyalkylene glycol derivatives, have already been used as such phlegmatizers, as described in DE 3226602 A1, EP 0432087 A1 and EP 1371671 A1 for example.

These systems are disadvantageous in that these compounds are not involved in the curing of the resins and are therefore almost unchanged in the cured compound and also have a plasticizing function therein. This has a negative effect on the properties of the cured compound, in particular the load values that can be achieved.

DE 4231161 A1 and DE 4337264 A1, for example, disclose an organic/inorganic hybrid system which contains hydraulically condensable compounds and thus allows water to be used as a phlegmatizer. After the components have been mixed, the water is bound by the hydraulically condensable compounds that are present and thus no longer has a plasticizing function in the cured compound.

However, these hybrid systems are disadvantageous in that, although some of the water reacts with the cement, a high water content remains, and this leads to lower failure loads than those that the water-free resin matrix would allow.

In order to keep the water proportion as low as possible, the hardener composition is therefore filled with fine fillers. However, as the filling level increases, so too does the viscosity of the component and thus the force with which such components can be ejected. Thus, with the hybrid systems currently available on the market, a compromise has to be found between high failure loads and processability of the compounds.

It is therefore the object of the invention to reduce the water content of hardener compositions that are already highly filled in the hardener composition, without significantly increasing the ejection force.

Theoretical concepts for optimizing the composition of mixtures are known, such as the Toufar or Fuller mixture. It is also known that a combination of different fillers has a positive effect on flowability. However, such models are relatively complex and the commercial preparation of such mixtures requires a large number of different raw materials, and so the use thereof is uneconomical, in particular expensive.

Surprisingly, it has been found that a simple mixture of two fillers having different average particle sizes (d₅₀) is sufficient to increase the possible filling level of a hardener composition based on an aqueous peroxide solution or suspension while maintaining flowability, provided that the average particle size (d₅₀) of the two fillers is within a certain ratio. The water content can be reduced by a higher filling level, i.e. a higher proportion of fillers.

The coarser fillers are preferably present as the main filler in a larger amount, and the smaller fillers are used in a smaller amount by comparison with the amount of main filler.

Using this invention, it is possible to formulate injection mortars having high performance and good processing properties. This is particularly important when packaging is intended to be carried out in environmentally friendly film packages, since it is difficult in this case to achieve high mixing ratios (resin composition:hardener composition).

Compared with the known highly filled, but difficult to eject hardener compositions, the hardener compositions according to the invention can be mixed well with the resin composition in a static mixer, and thus lead to stable hardening of the injection mortar.

For better understanding of the invention, the following explanations of the terminology used herein are considered to be useful. Within the meaning of the invention:
a “reaction resin,” also referred to as “base resin,” is a usually solid or high-viscosity “radically curable,” i.e. polymerizable, compound, which cures by means of polymerization and forms a resin matrix; the reaction resin is the reaction product of a bulk reaction per se; this also includes the reaction batch for producing the base resin after the reaction has ended, which is present without the product being isolated and therefore can contain the reaction resin, a reactive diluent, a stabilizer and a catalyst, if used, in addition to the radically curable compound;
an “inhibitor” is a compound capable of inhibiting the polymerization reaction (curing), which serves to avoid the polymerization reaction and thus an undesired premature polymerization of the polymerizable compound, i.e. the reaction resin, during storage (in this function, often also referred to as a stabilizer) and/or to delay the start of the polymerization reaction immediately after adding the hardener; the role of the inhibitor depends on the quantities in which it is used;
“reactive diluents” are liquid or low-viscosity monomers and oligomers which dilute the reaction resin and thereby give it the viscosity required for its application, contain one or more functional groups capable of reacting with the reaction resin and are predominantly constituents of the cured compound (resin matrix) during polymerization (curing);
“hardeners” are substances that cause the polymerization (curing) of the polymerizable compound, i.e. the reaction resin;
an “accelerator” is a compound capable of accelerating the polymerization reaction (curing), which serves to accelerate the formation of radicals;
a “filler” is an organic or inorganic, in particular inorganic, compound that can be passive and/or reactive and/or functional; “passive” means that the compound is surrounded unchanged by the curing resin matrix; “reactive” means that the compound polymerizes into the resin matrix and forms an expanded network with the reaction resin; “functional” means that the compound is not polymerized into the resin matrix but fulfills a certain function in the formulation, with “additives” also being referred to in this case;
a “resin composition” is a mixture consisting of the polymerizable compound, i.e. the reaction resin, and inorganic and/or organic additives and fillers, such as an inhibitor and/or an accelerator;
a “hardener composition” is a mixture consisting of the hardener and inorganic and/or organic fillers, such as a phlegmatizer, i.e. a stabilizer for the hardener;
“highly filled hardener composition” means that the majority of the hardener composition consists of fillers, in particular inorganic fillers, and therefore said composition has a high filling level of above 50 vol. % of fillers;
the “total filling level” is the sum of all fillers or solids including any solid peroxides and including the first filler FS1 and the second filler FS2;
the “basic filling level” is the sum of all fillers or solids including any solid peroxides, before the addition of the first filler FS1 and the second filler FS2;
the “maximum filling level” is the filling level at which, after the addition of the first filler FS1 but before the addition of the second filler FS2, the ejection force of the hardener composition has reached at least three times the ejection force obtained with a filling level of 2 vol. % less;
the “limit filling level” is the filling level at which the hardener composition can still be easily ejected, which results from the maximum filling level and contains so much less of the first filler FS1 that the filling level is reduced by approximately 5 vol. % by comparison with the maximum filling level;
a “two-component reaction resin system” is a reaction resin system that comprises two components stored separately from one another, generally a resin component containing the resin composition and a hardener component containing the hardener composition, so that the reaction resin cures only after the two components have been mixed;
a “multi-component reaction resin system” is a reaction resin system that comprises a plurality of components stored separately from one another, so that the reaction resin cures only after all components have been mixed;
“(meth)acrylic . . . / . . . (meth)acrylic. . .” means both the “methacrylic . . . / . . . methacrylic . . . ” compounds and the “acrylic . . . / . . . acrylic . . . ” compounds; “methacrylic . . . / . . . methacrylic . . . ” compounds are preferred in the present invention:
“a” or “an” as the article preceding a class of chemical compounds, e.g. preceding the word “reactive diluent,” means that one or more compounds included in this class of chemical compounds, e.g. various “reactive diluents”, may be intended;
“at least one” means numerically “one or more”; in a preferred embodiment, the term means numerically “one”;
“contain” and “comprise” mean that more constituents may be present in addition to the mentioned constituents; these terms are meant to be inclusive and therefore also include “consist of”; “consist of” is meant exclusively and means that no further constituents may be present; in a preferred embodiment, the terms “contain” and “comprise” mean the term “consist of”;
“approximately” before a numerical value means a range of ±5% of this value, preferably ±2% of this value, particularly preferably ±0% of this value (i.e. exactly this value);
a range limited by numbers means that the two extreme values and any value within this range are disclosed individually.

All standards cited in this text (e.g. DIN standards) were used in the version that was current on the filing date of this application.

A first subject of the invention is a hardener composition for a reactive resin system comprising a reactive resin based on radically curable compounds, wherein the hardener composition comprises a hardener for the reactive resin and a filler mixture, which is characterized in that the filler mixture consists of a first filler FS1 having a first average particle size d_{50,1} and a second filler FS2 having a second average particle size d_{50,2}, wherein the first average particle size d_{50,1} of the first filler is greater than the second average particle size d_{50,2} of the second filler (d_{50,1}>d_{50,2}) and the ratio d_{50,1} to d_{50,2} (d_{50,1}:d_{50,2}) is in the range of approximately 8:1 to approximately 100:1.

Fillers/Filler Mixture

With the mixture according to the invention of two fillers having different average particle sizes (d₅₀), the possible filling level of a hardener composition, in particular a hardener composition based on a water-based or solvent-based peroxide composition, can be increased by more than 5 vol. % and, depending on the filler mixture, even by more than 8 vol. %, based in each case on the hardener composition, while maintaining the fiowability of the hardener composition.

According to the invention, the filler mixture consists of a first filler FS1 having a first average particle size d_{50,1} and a second filler FS2 having a second average particle size d_{50,2}, wherein the first average particle size d_{50,1} of the first filler FS1 is greater than the second average particle size d_{50,2} of the second filler FS2 (d_{50,1}>d_{50,2}) and the ratio d_{50,1} to d_{50,2} (d_{50,1}:d_{50,2}) is in the range of 8:1 to 100:1.

The first average particle size d_{50,1} of the first filler FS1 is preferably 16 μm to 130 μm. The second average particle size d_{50,2} of the second filler FS2 is preferably 0.16 μm to 16 μm.

The chemical composition of the fillers is of secondary importance. Natural or synthetic inorganic materials preferably having medium or high hardness, in particular a Mohs hardness between 2 and 10, are suitable. However, organic solids can also be used.

Suitable fillers are, for example, metal oxides or semi-metal oxides such as aluminum oxide or titanium dioxide; metal hydroxides such as aluminum hydroxide; salts such as calcium carbonate or barium sulfate: mineral or mineral-like fillers such as various silicates or aluminates and mixtures thereof, e.g. quartz, glass, sand, quartz sand, quartz powder, porcelain, corundum, ceramic, talc, silica (e.g. fumed silica), silicates, clay, chalk, barite, feldspar, basalt, granite or sandstone, glasses, ceramics, and natural stones such as basalt; hydraulically curable fillers, such as gypsum, quicklime or cement (e.g. alumina or Portland cement); metals such as aluminum; carbon black; polymer fillers such as thermosets.

The first filler FS1 is preferably selected from semi-metal oxides metal oxides, semi-metal oxides and metal hydroxides, such as silicon dioxide, in particular quartz, aluminum oxide and aluminum hydroxide.

The second filler FS2 is also preferably selected from the group consisting of metal salts such as calcium carbonate or barium sulfate.

According to a particularly preferred embodiment of the invention, the coarser fillers are present as the main filler in a larger amount, and the smaller fillers are used in a smaller amount by comparison with the amount of main filler. The proportion of first filler FS1 is thus greater than the proportion of second filler FS2.

The proportion of fillers is expediently indicated as a proportion by volume. However, the amount of first filler FS1 and second filler FS2 to be used depends on the fillers used in each case, more precisely on their particle size, and cannot be described all-inclusively by a numerical value.

The maximum amount of first filler should accordingly be experimentally determined separately for each filler FS1. The maximum amount is the amount of first filler FS1 starting from which the second filler FS2 is added in a corresponding amount in order to obtain the filler mixture.

The maximum amount of first filler FS1 is determined as follows: First, the amount (sum) of all solids including any solid peroxides and optionally further solids, such as solid additives, is determined before the addition of the first filler FS1 and the second filler FS2. This corresponds to the basic filling level. Starting from this basic filling level, the first filler FS1 is added gradually and the ejection force is determined after each addition. If the ejection force has increased exponentially for the first time by a multiple, for example by three times or more. If no further addition of first filler is required. The amount of first filler FS1 at which the exponential increase in the ejection force is observed for the first time is referred to as the maximum filling level. Starting from this maximum filling level, a certain amount of first filler FS1 is removed such that the filling level is again in a range in which the ejection force is still low. This filling level, at which the composition can still be easily ejected, and which contains the sum of all solids including any solid peroxides and including the first filler FS1, is referred to as the limit filling level.

Starting from the limit filling level, the second filler FS2 is then added, it being possible for the total filling level to exceed the amount of the maximum filling level without the ejection forces noticeably increasing. The total filling level corresponds to the sum of the basic filling level and the filler mixture FS1 and FS2.

The maximum amount of first filler FS1 having the average particle size d_{50,1} can be determined in particular by adding the filler FS1 to the hardener composition in increments of 2 vol. % until the ejection force of the hardener composition has at least tripled for the first time by comparison with the previous step (previous addition). After each increase in the filling level, the ejection force is determined at a given temperature (+23° C.). The proportion of first filler FS1 is increased until the ejection force has increased by three times the previous value in each case. The filling level thus achieved, optionally including the basic filling level of the solid peroxide and possibly further solids, is referred to as the maximum filling level. Since the proportion of filler FS1 is already too high at this filling level to achieve or exploit the maximum effect of the invention, the amount of first filler FS1 is reduced again, starting from the maximum filling level. A reduction in the proportion of first filler FS1 in the hardener composition by approximately 5 vol. % has proven to be expedient.

The second filler FS2 having the average particle size d_{50,2} is added to this amount of filler FS1 in order to obtain the filler mixture according to the invention. The amount of second filler FS2 is selected such that the volume ratio of first filler to second filler (V_{FS1}:V_{FS2}) is in the range of 1.5:1 to 15:1, preferably 2:1 to 10:1, and more preferably 2.5:1 to 5:1.

Hardener for Radically Curable. Ethylenically Unsaturated Compounds

If the hardener composition is used for resin compositions based on radically curable, ethylenically unsaturated compounds, the hardener composition contains a hardener for the radically curable, ethylenically unsaturated compound.

Any of the peroxides known to a person skilled in the art that can be used to cure methacrylate resins can be used. Peroxides of this kind include organic and inorganic peroxides, either liquid or solid. Examples of suitable organic peroxides are peroxycarbonates (of formula —OC(O)OO—), peroxyesters (of formula —C(O)OO—), diacyl peroxides (of formula —C(O)OOC(O)—), dialkyl peroxides (of formula —OO—) and the like.

These may also be present as oligomers or polymers. A comprehensive set of examples of suitable peroxides is described, for example, in application US 2002/0091214 A1, paragraph [0018].

The peroxides are preferably selected from the group of organic peroxides. Suitable organic peroxides are: tertiary alkyl hydroperoxides such as tert-butyl hydroperoxide and other hydroperoxides such as cumene hydroperoxide, peroxyesters or peracids such as tert-butyl peresters (e.g. tert-butyl peroxybenzoate), dibenzoyl peroxide, peracetates and perbenzoates, dilauroyl peroxide including (di)peroxyesters, perethers such as peroxy diethyl ether, perketones, such as methyl ethyl ketone peroxide. The organic peroxides used as curing agents are often tertiary peresters or tertiary hydroperoxides, i.e. peroxide compounds having tertiary carbon atoms which are bonded directly to an —O—O-acyl or —OOH group. However, mixtures of these peroxides with other peroxides can also be used according to the invention. The peroxides may also be mixed peroxides, i.e. peroxides which have two different peroxide-carrying units in one molecule. Preferably, dibenzoyl peroxide (BPO) or tert-butyl peroxybenzoate is used for curing.

In particular, persulfates, perborates and/or perphosphates, such as ammonium persulfate, potassium and sodium monopersulfates or potassium and sodium dipersulfates, can be used as inorganic peroxides. Hydrogen peroxide can also be used, however.

The use of organically substituted ammonium persulfates (for example N′N′N′N′-tetrabutylammonium or N′N′N′-tricapryl-N′-methylammonium persulfate is also possible.

According to the invention, in addition to the peroxide, the hardener composition also contains a phlegmatizer for stabilizing the peroxide. Corresponding phlegmatizers are known from DE 3226602 A1, EP 0432087 A1 and EP 1 371 671 A1.

The hardener composition preferably contains water as a phlegmatizer. In addition to the water, the hardener composition can also contain further phlegmatizers, water being preferred as the sole phlegmatizer in order not to introduce any compounds which have a softening effect.

The peroxide is preferably present as a suspension together with the water. Corresponding suspensions are commercially available in different concentrations, such as the aqueous dibenzoyl peroxide suspensions from United Initiators (e.g. BP40SAQ), Perkadox 40L-W (Nouryon), Luperox® EZ-FLO (Arkema), Peroxan BP40W (Pergan). The reaction resin system can contain the peroxide in an amount of 0.25 to 35 wt. %, preferably 1 to 30 wt. %, particularly preferably 5 to 25 wt. %, based on the hardener composition.

The action of the filler mixture described at the outset becomes particularly apparent in the case of water-containing hardener compositions. In these systems, the use of the filler mixture is particularly advantageous, since not only the proportion of low-viscosity constituents, but in particular also the proportion of water, which has a disadvantageous effect on curing, can be reduced.

Other Added Substances

In addition to water and the hardener, commercial peroxide dispersions contain other added substances, such as emulsifiers, antifreeze agents, buffers and rheological additives in undisclosed types and quantities.

In addition, the hardener composition can additionally contain other added substances or additives, namely emulsifiers, antifreeze agents, buffers and/or rheological additives. The hardener composition according to the invention preferably does not contain any further organic or inorganic solids, in particular fillers. However, it is not excluded that additional organic and/or inorganic solids may be contained, provided that these do not adversely affect the effect according to the invention.

Suitable emulsifiers are: ionic, nonionic or amphoteric surfactants; soaps, wetting agents, detergents; polyalkylene glycol ethers; salts of fatty acids, mono- or diglycerides of fatty acids, sugar glycerides, lecithin; alkanesulfonates, alkylbenzenesulfonates, fatty alcohol sulfates, fatty alcohol polyglycol ethers, fatty alcohol ether sulfates, sulfonated fatty acid methyl esters; fatty alcohol carboxylates; alkyl polyglycosides, sorbitan esters, N-methyl glucamides, sucrose esters; alkyl phenols, alkyl phenol polyglycol ethers, alkyl phenol carboxylates; quaternary ammonium compounds, esterquats, carboxylates of quaternary ammonium compounds.

Suitable antifreeze agents are: organic or inorganic, water-soluble additives that lower the freezing temperature of the water; mono-, bi- or higher-functional alcohols such as ethanol, n- or iso-propanol, n-, iso- or tert-butanol and the like; ethylene glycol, 1,2- or 1,3-propylene glycol, glycerol, trimethylol propane and the like; oligo- or polyglycols such as dialkylene glycols, trialkylene glycols and the like; sugars, especially mono- or disaccharides; trioses, tetroses, pentoses and hexoses in their aldehyde or keto form, and the analogous sugar alcohols. Examples include, but are not limited to, glyceraldehyde, fructose, glucose, sucrose, mannitol and the like.

Suitable buffers are organic or inorganic acid/base pairs that stabilize the pH of the hardener composition, such as acetic acid/alkali acetate, citric acid/monoalkali citrate, monoalkali/dialkali citrate, dialkali/trialkali citrate, combinations of mono-, di- and/or tri-basic alkali phosphates, optionally with phosphoric acid; ammonia with ammonium salts; carbonic acid-bicarbonate buffers and the like. Intramolecular, so-called Good buffers can also be used, such as 4-(2-hydroxyethyl)-1-piperazineethanesulfonic acid (HEPES) or 2-(N-morpholino)ethanesulfonic acid (MES) as well as tris(hydroxymethyl)aminomethane (TRIS) and the like.

The flow properties are adjusted by adding thickening substances, also known as rheological additives. Suitable rheological additives are: phyllosilicates such as laponites, bentones or montmorillonite, Neuburg siliceous earth, fumed silicas, polysaccharides; polyacrylate, polyurethane or polyurea thickeners and cellulose esters. Wetting agents and dispersants, surface additives, defoamers & deaerators, wax additives, adhesion promoters, viscosity reducers or process additives can also be added for optimization. These additives also have to be selected such that they do not adversely affect the effect according to the invention.

The sum of the added substances not already contained in the commercial products, such as (rheological additives, emulsifiers, antifreeze agents and the like, can be from 0 to 30 wt. %, preferably 0 to 25 wt. %, particularly preferably 0 to 20 wt. %, based in each case on the hardener composition.

Use of the Filler Mixture

The filler mixture described above is advantageously used in a hardener composition for a reactive resin composition comprising a reactive resin based on radically curable, ethylenically unsaturated compounds for chemical fastening, in order to increase the filler proportion without negatively affecting the flowability of the hardener composition. This makes it possible to significantly reduce the proportion of liquid constituents in the hardener composition, in particular water, and to provide for low ejection forces despite the high proportion of fillers.

A further subject of the invention is therefore the use of a filler mixture consisting of a first filler FS1 having a first average particle size d_{50,1} and a second filler FS2 having a 15 second average particle size d_{50,2}, wherein the first average particle size d_{50,1} of the first filler FS1 is greater than the second average particle size d_{50,2} of the second filler FS2 (d_{50,1}>d_{50,2}) and the ratio d_{50,1} to d_{50,2} (d_{50,1}:d_{50,2}) is in the range of 8:1 to 100:1, in a hardener composition for a reactive resin composition comprising a reactive resin based on radically curable, ethylenically unsaturated compounds for chemical fastening, in order to increase the filler proportion, while maintaining the flowability of the hardener composition.

The hardener composition according to the invention can advantageously be used as a hardener component in a multi-component reaction resin system, which also includes two-component reaction resin systems.

A further subject of the invention is therefore a multi-component reaction resin system comprising a resin component and the hardener composition described above as a hardener component. The resin component contains at least one radically curable unsaturated compound. The radically curable unsaturated compound can be a reaction resin. Alternatively, the one radically curable unsaturated compound can be a reactive diluent. According to a further alternative, the radically curable unsaturated compound can also comprise a mixture consisting of at least one reaction resin and at least one reactive diluent, i.e. a reaction resin mixture.

Radically Curable, Ethylenically Unsaturated Compound

Radically curable unsaturated compounds that are suitable as a reaction resin are ethylenically unsaturated compounds, i.e. compounds which have carbon-carbon triple bonds, and thiol-yne/ene resins, as are known to a person skilled in the art.

Theradically curable, ethylenically unsaturated compound, i.e. the reaction resin, is particularly preferably a compound based on urethane (meth)acrylate, a compound based on epoxy (meth)acrylate, a (meth)acrylate of an alkoxylated bisphenol, or a compound based on other ethylenically unsaturated compounds.

Of these compounds, the group of ethylenically unsaturated compounds is preferred, which group comprises styrene and derivatives thereof, (meth)acrylates, vinyl esters, unsaturated polyesters, vinyl ethers, allyl ethers, itaconates, dicyclopentadiene compounds and unsaturated fats, of which unsaturated polyester resins and vinyl ester resins are particularly suitable and are described, for example, in applications EP 1 935 860 A1, DE 195 31 649 A1, WO 02/051903 A1 and WO 10/108939 A1. Vinyl ester resins (synonym: (meth)acrylate resins) are in this case most preferred due to their hydrolytic resistance and excellent mechanical properties. Vinyl ester urethane resins, in particular urethane methacrylates, are very particularly preferred. These include, as preferred resins, the urethane methacrylate resins described in DE 10 2011 017 626 B4. In this regard, reference is made to DE 10 2011 017 626 B4, and above all its description of the composition of these resins, in particular in the examples of DE 10 2011 017 626 B4.

Examples of suitable unsaturated polyesters which can be used according to the invention are divided into the following categories, as classified by M. Malik et al. in J. M. S.—Rev. Macromol. Chem. Phys., C40 (2 and 3), pp. 139-165 (2000):

(1) ortho-resins: these are based on phthalic anhydride, maleic anhydride or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol A;

(2) iso-resins: these are prepared from isophthalic acid, maleic anhydride or fumaric acid and glycols. These resins can contain higher proportions of reactive diluents than the ortho-resins;

(3) bisphenol A fumarates: these are based on ethoxylated bisphenol A and fumaric acid;

(4) HET acid resins (hexachloroendomethylene tetrahydrophthalic acid resins): these are resins obtained from chlorine/bromine-containing anhydrides or phenols during the preparation of unsaturated polyester resins.

In addition to these resin classes, what are referred to as dicyclopentadiene resins (DCPD resins) can also be distinguished as unsaturated polyester resins. The class of DCPD resins is either obtained by modifying one of the above-mentioned resin types by means of a Diels-Alder reaction with cyclopentadiene, or said resins are alternatively obtained by means of a first reaction of a dicarboxylic acid, for example maleic acid, with dicyclopentadienyl and then by means of a second reaction of the usual preparation of an unsaturated polyester resin, the latter being referred to as a DCPD maleate resin.

The unsaturated polyester resin preferably has a molecular weight Mn in the range of 500 to 10,000 daltons, more preferably in the range of 500 to 5,000 and even more preferably in the range of 750 to 4,000 (according to ISO 13885-1). The unsaturated polyester resin has an acid value in the range of 0 to 80 mg KOH/g resin, preferably in the range of 5 to 70 mg KOH/g resin (according to ISO 2114-2000). If a DCPD resin is used as the unsaturated polyester resin, the acid value is preferably 0 to 50 mg KOH/g resin.

In the context of the invention, vinyl ester resins are oligomers, prepolymers or polymers having at least one (meth)acrylate end group, what are referred to as (meth)acrylate-functionalized resins, which also include urethane (meth)acrylate resins and epoxy (meth)acrylates.

Vinyl ester resins, which have unsaturated groups only in the end position, are obtained, for example, by reacting epoxy oligomers or polymers (for example bisphenol A digylcidyl ether, phenol novolac-type epoxies or epoxy oligomers based on tetrabromobisphenol A) with (meth)acrylic acid or (meth)acrylamide, for example. Preferred vinyl ester resins are (meth)acrylate-functionalized resins and resins which are obtained by reacting an epoxy oligomer or polymer with methacrylic acid or methacrylamide, preferably with methacrylic acid, and optionally with a chain extender, such as diethylene glycol or dipropylene glycol. Examples of such compounds are known from applications U.S. Pat. Nos. 3,297,745 A, 3,772,404 A, 4,618,658 A, GB 2217722 A1, DE 3744390 A1 and DE 4131457 A1.

Particularly suitable and preferred vinyl ester resins are (meth)acrylate-functionalized resins, which are obtained, for example, by reacting di- and/or higher-functional isocyanates with suitable acrylic compounds, optionally with the help of hydroxy compounds that contain at least two hydroxyl groups, as described for example in DE 3940309 A1. Very particularly suitable and preferred are the urethane methacrylate resins (which are also referred to as vinyl ester urethane resins) described in DE 10 2011 017 626 B4.

Aliphatic (cyclic or linear) and/or aromatic di- or higher-functional isocyanates or prepolymers thereof can be used as isocyanates. The use of such compounds serves to increase wettability and thus to improve the adhesive properties. Aromatic di- or higher-functional isocyanates or prepolymers thereof are preferred, aromatic di- or higher-functional prepolymers being particularly preferred. Toluylene diisocyanate (TDI), diisocyanatodiphenylmethane (MDI) and polymeric diisocyanatodiphenylmethane (pMDI) for increasing chain stiffening, and hexane diisocyanate (HDI) and isophorone diisocyanate (IPDI), which improve flexibility, may be mentioned by way of example, of which polymeric diisocyanatodiphenylmethane (pMDI) is very particularly preferred.

Suitable acrylic compounds are acrylic acid and acrylic acids substituted on the hydrocarbon group, such as methacrylic acid, hydroxyl-group-containing esters of acrylic or methacrylic acid with polyhydric alcohols, pentaerythritol tri(meth)acrylate, glycerol di(meth)acrylate, such as trimethylolpropane di(meth)acrylate and neopentyl glycol mono(meth)acrylate. Acrylic or methacrylic acid hydroxyalkyl esters, such as hydroxyethyl (meth)acrylate, hydroxypropyl (meth)acrylate, polyoxyethylene (meth)acrylate, polyoxypropylene (meth)acrylate, are preferred, especially since such compounds serve to sterically prevent the saponification reaction. Because of its lower alkali stability, acrylic acid is less preferred than acrylic acids substituted on the hydrocarbon group.

Hydroxy compounds that can optionally be used are suitable dihydic or higher alcohols, for example secondary products of ethylene oxide or propylene oxide, such as ethanediol, di- or triethylene glycol, propanediol, dipropylene glycol, other diols, such as 1,4-butanediol, 1,6-hexanediol, neopentyl glycol, diethanolamine, further bisphenol A or F or their ethoxylation/propoxylation and/or hydrogenation or halogenation products, higher alcohols, such as glycerol, trimethylolpropane, hexanetriol and pentaerythritol, hydroxyl-group-containing polyethers, for example oligomers of aliphatic or aromatic oxiranes and/or higher cyclic ethers, such as ethylene oxide, propylene oxide, styrene oxide and furan, polyethers which contain aromatic structural units in the main chain, such as those of bisphenol A or F, hydroxyl-group-containing polyesters based on the above-mentioned alcohols or polyethers and dicarboxylic acids or their anhydrides, such as adipic acid, phthalic acid, tetra- or hexahydrophthalic acid, HET acid, maleic acid, fumaric acid, itaconic acid, sebacic acid and the like. Particularly preferred are hydroxy compounds having aromatic structural units to reinforce the chain of the resin, hydroxy compounds containing unsaturated structural units, such as fumaric acid, to increase the crosslinking density, branched or star-shaped hydroxy compounds, in particular trihydric or higher alcohols and/or polyethers or polyesters containing the structural units thereof, branched or star-shaped urethane (meth)acrylates to achieve lower viscosity of the resins or their solutions in reactive diluents and higher reactivity and crosslinking density.

The vinyl ester resin preferably has a molecular weight Mn in the range of 500 to 3,000 daltons, more preferably 500 to 1,500 daltons (according to ISO 13885-1). The vinyl ester resin has an acid value in the range of 0 to 50 mg KOH/g resin, preferably in the range of 0 to 30 mg KOH/g resin (according to ISO 2114-2000).

All of these reaction resins that can be used according to the invention as radically curable unsaturated compounds can be modified according to methods known to a person skilled in the art, for example to achieve lower acid numbers, hydroxide numbers or anhydride numbers, or can be made more flexible by introducing flexible units into the backbone, and the like.

In addition, the reaction resin may contain other reactive groups that can be polymerized with a radical initiator, such as peroxides, for example reactive groups derived from itaconic acid, citraconic acid and allylic groups and the like.

In one embodiment, the resin component of the reaction resin system contains, in addition to the reaction resin, at least one further low-viscosity, radically polymerizable, ethylenically unsaturated compound as the reactive diluent. This is expediently added to the reaction resin and is therefore contained in the resin component.

Suitable, in particular low-viscosity, radically curable, ethylenically unsaturated compounds as reactive diluents are described in applications EP 1935860 A1 and DE 19531649 A1. The reactive resin system preferably contains a (meth)acrylic acid ester as a reactive diluent, with (meth)acrylic acid esters being particularly preferably selected from the group consisting of hydroxypropyl (meth)acrylate, propanediol-1,3-di(meth)acrylate, butanediol-1,2-di(meth)acrylate, trimethylolpropane tri(meth)acrylate, 2-ethylhexyl (meth)acrylate, phenylethyl (meth)acrylate, tetrahydrofurfuryl (meth)acrylate, ethyl triglycol (meth)acrylate, N,N-dimethylaminoethyl (meth)acrylate, N,N-dimethylaminomethyl (meth)acrylate, butanediol-1,4-di(meth)acrylate, butanediol-1,3-di(meth)acrylate, hexanediol-1,6-di(meth)acrylate, acetoacetoxyethyl (meth)acrylate, ethanediol-1,2-di(meth)acrylate, isobornyl (meth)acrylate, di-, tri- or oligoethylene glycol di(meth)acrylate, methoxypolyethylene glycol mono(meth)acrylate, trimethylcyclohexyl(meth)acrylate, 2-hydroxyethyl(meth)acrylate, dicyclopentenyloxyethyl (meth)acrylate and/or tricyclopentadienyl di(meth)acrylate, bisphenol A (meth)acrylate, novolac epoxy di(meth)acrylate, di[(meth)acryloyl-maleoyl]tricyclo-5.2.1.0.^{2,6}-decane, dicyclopentenyloxyethyl crotonate, 3-(meth)acryloyloxymethyltricylo-5.2.1.0.^{2,6}-decane, 3-(meth)cyclopentadienyl (meth)acrylate, isobornyl (meth)acrylate and decalyl-2-(meth)acrylate. Biogenic reactive diluents such as tetrahydrofurfuryl (meth)acrylate, isobornyl (meth)acrylate or isosorbide di(meth)acrylate are preferred.

The reactive diluent can be used alone or as a mixture consisting of two or more reactive diluents.

In principle, other conventional radically polymerizable compounds, alone or in a mixture with the (meth)acrylic acid esters described in the preceding paragraph, can also be used, e.g. styrene, α-methylstyrene, alkylated styrenes, such as tert-butylstyrene, divinylbenzene, and vinyl and allyl compounds. Examples of vinyl or allyl compounds of this kind are hydroxybutyl vinyl ether, ethylene glycol divinyl ether, 1,4-butanediol divinyl ether, trimethylolpropane divinyl ether, trimethylolpropane trivinyl ether, mono-, di-, tri-, tetra- and polyalkylene glycol vinyl ether, mono-, di-, tri-, tetra- and polyalkylene glycol allyl ether, adipic acid divinyl ester, trimethylolpropane diallyl ether and trimethylolpropane triallyl ether.

Particularly preferred reactive diluents are the reactive diluents used in the examples.

Compounds which have different reactive or functional groups can also be used as radically curable compounds. These can both be, for example, ethylenically unsaturated, such as (meth)acrylates having an additional allyl ether function. However, compounds having two different reactive/functional groups that react with different reaction mechanisms can be used. Examples are (meth)acrylates having a silane or siloxane group, such as 3-trimethoxysilylpropyl methacrylate. Compounds having more than two reactive/functional groups can also be used.

The reaction resin system can contain the radically curable unsaturated compound in an amount of 10 to 99.99 wt. %, preferably 15 to 97 wt. %, particularly preferably 30 to 95 wt. %, based on the resin component. The radically curable compound can be either a reaction resin based on a radically curable compound or a reactive diluent or a mixture of a reaction resin with one, two or more reactive diluents.

In cases where the radically curable unsaturated compound is a reaction resin mixture, the amount of the mixture which can be contained in the reaction resin system corresponds to the amount of the radically curable compound, specifically from 10 to 99.99 wt. %, preferably 15 to 97 wt. %, particularly preferably 30 to 95 wt. %, based on the resin component, and, based on the reaction resin mixture, the proportion of the reaction resin is 0 to 100 wt. %, preferably 30 to 70 wt. %, and the proportion of the reactive diluent or a mixture consisting of a plurality of reactive diluents is 0 to 100 wt. %, preferably 30 to 70 wt. %.

The total amount of the radically curable compound depends on the filling level, i.e. the amount of inorganic fillers, including the fillers listed below, in particular the hydrophilic fillers, the further inorganic aggregates and the hydraulically setting or polycondensable compounds.

Accelerator

In a further embodiment, the reaction resin system also contains at least one accelerator. This accelerates the curing reaction.

Suitable accelerators are known to a person skilled in the art. These are expediently amines.

Suitable amines are selected from the following compounds, which are described in application US 2011071234 A1, for example: dimethylamine, trimethylamine, ethylamine, diethylamine, triethylamine, n-propylamine, di-n-propylamine, tri-n-propylamine, iso-propylamine, di-iso-propylamine, tri-iso-propylamine, n-butylamine, iso-butylamine, tert-butylamine, di-n-butylamine, di-iso-butylamine, tri-iso-butylamine, pentylamine, iso-pentylamine, di-iso-pentylamine, hexylamine, octylamine, dodecylamine, laurylamine, stearylamine, aminoethanol, diethanolamine, triethanolamine, aminohexanol, ethoxyaminoethane, dimethyl(2-chloroethyl)amine, 2-ethylhexylamine, bis(2-chloroethyl)amine, 2-ethylhexylamine, bis(2-ethylhexyl)amine, N-methylstearylamine, dialkylamines, ethylenediamine, N,N′-dimethylethylenediamine, tetramethylethylenediamine, diethylenetriamine, permethyldiethylenetriamine, triethylenetetramine, tetraethylenepentamine, 1,2-diaminopropane, di-propylenetriamine, tripropylenetetramine, 1,4-diaminobutane, 1,6-diaminohexane, 4-amino-1-diethylaminopentane, 2,5-diamino-2,5-dimethylhexane, trimethylhexamethylenediamine, N,N-dimethylaminoethanol, 2-(2-diethylaminoethoxy)ethanol, bis(2-hydroxyethyl)oleylamine, tris[2(2-hydroxyethoxy)ethyl]amine, 3-amino-1-propanol, methyl(3-aminopropyl)ether, ethyl-(3-aminopropyl)ether, 1,4-butanediol-bis(3-aminopropyl)ether, 3-dimethylamino-1-propanol, 1-amino-2-propanol, 1-diethylamino-2-propanol, di-iso-propanolamine, methyl-bis(2-hydroxypropyl)amine, tris(2-hydroxypropyl)amine, 4-amino-2-butanol, 2-amino-2-methylpropanol, 2-amino-2-methylpropanediol, 2-amino-2-hydroxymethylpropanediol, 5-diethylamino-2-pentanone, 3-methylaminopropionitrile, 6-aminohexanoic acid, 11-aminoundecanoic acid, 6-aminohexanoic acid ethyl ester, 11-aminohexanoate-isopropyl ester, cyclohexylamine, N-methylcyclohexylamine, N,N-dimethylcyclohexylamine, dicyclohexylamine, N-ethylcyclohexylamine, N-(2-hydroxyethyl)cyclohexylamine, N,N-bis(2-hydroxyethyl)cyclohexylamine, N-(3-aminopropyl)cyclohexylamine, aminomethylcyclohexane, hexahydrotoluidine, hexahydrobenzylamine, aniline, N-methylaniline, N,N-dimethylaniline, N,N-diethylaniline, N,N-di-propylaniline, iso-butylaniline, toluidine, diphenylamine, hydroxyethylaniline, bis(hydroxyethyl)aniline, chloroaniline, aminophenols, aminobenzoic acids and esters thereof, benzylamine, dibenzylamine, tribenzylamine, methyldibenzylamine, α-phenylethylamine, xylidine, di-iso-propylaniline, dodecylaniline, aminonaphthalene, N-methylaminonaphthalene, N,N-dimethylaminonaphthalene, N,N-dibenzylnaphthalene, diaminocyclohexane, 4,4′-diamino-dicyclohexylmethane, diamino-dimethyl-dicyclohexylmethane, phenylenediamine, xylylenediamine, diaminobiphenyl, naphthalenediamines, benzidines, 2,2-bis(aminophenyl)propane, aminoanisoles, aminothiophenols, aminodiphenyl ethers, aminocresols, morpholine, N-methylmorpholine, N-phenylmorpholine, hydroxyethylmorpholine, N-methylpyrrolidine, pyrrolidine, piperidine, hydroxyethylpiperidine, pyrroles, pyridines, quinolines, indoles, indolenines, carbazoles, pyrazoles, imidazoles, thiazoles, pyrimidines, quinoxalines, aminomorpholine, dimorpholineethane, [2,2,2]-diazabicyclooctane and N,N-dimethyl-p-toluidine.

Preferred amines are symmetrically or asymmetrically substituted aniline and toluidine derivatives and N,N-bis(hydroxy)alkylarylamines, such as N,N-dimethylaniline, N,N-diethylaniline, N,N-dimethyl-p-toluidine, N,N-bis(hydroxyalkyl)arylamines, N,N-bis(2-hydroxyethyl)aniline, N,N-bis(2-hydroxyethyl)toluidine, N,N-bis(2-hydroxypropyl)aniline, N,N-bis(2-hydroxypropyl)toluidine, N,N-bis(3-methacryloyl-2-hydroxypropyl)-p-toluidine, N,N-dibutoxyhydroxypropyl-p-toluidine, N-methyl-N-hydroxyethyl-p-toluidine, N-ethyl-N-hydroxyethyl-p-toluidine and the analog o- or m-toluidines and 4,4′-bis(dimethylamino)diphenylmethane and/or the leuco forms of the dyes crystal violet or malachite green.

Polymeric amines, such as those obtained by polycondensation of N,N-bis(hydroxyalkyl)aniline with dicarboxylic acids or by polyaddition of ethylene oxide and these amines, are also suitable as accelerators.

Preferred accelerators are N,N-bis(2-hydroxypropyl)toluidine. N,N-bis(2-hydroxyethyl)toluidine and para-toluidine ethoxylate (Bisomer® PTE).

The reaction resin system can contain the accelerator in an amount of 0.01 to 10 wt. %, preferably 0.5 to 5 wt. %, particularly preferably 0.5 to 3 wt. %, based on the resin component.

Inhibitors

In yet a further embodiment, the resin component also contains an inhibitor both for the storage stability of the reaction resin and the resin component and for adjusting the gel time. The reaction resin system can contain the inhibitor alone or together with the accelerator. A suitably coordinated accelerator-inhibitor combination is preferably used to set the processing time or gel time.

The inhibitors which are conventionally used for radically polymerizable compounds, as are known to a person skilled in the art, are suitable as inhibitors. The inhibitors are preferably selected from phenolic compounds and non-phenolic compounds, such as stable radicals and/or phenothiazines.

Suitable phenolic inhibitors are phenols, such as 2-methoxyphenol, 4-methoxyphenol, 2,6-di-tert-butyl-4-methylphenol, 2,4-di-tert-butylphenol, 2,6-di-tert-butylphenol, 2,4,6-trimethylphenol, 2,4,6-tris(dimethylaminomethyl)phenol, 4,4′-thio-bis(3-methyl-6-tert-butylphenol), 4,4′-isopropylidenediphenol, 6,6′-di-tert-butyl-4,4′-bis(2,6-di-tert-butylphenol), 1,3,5-trimethyl-2,4,6-tris(3,5-di-tert-butyl-4-hydroxybenzyl)benzene, 2,2′-methylene-di-p-cresol, pyrocatechol and butylpyrocatechols such as 4-tert-butylpyrocatechol, 4,6-di-tert-butylpyrocatechol, hydroquinones such as hydroquinone, 2-methylhydroquinone, 2-tert-butylhydroquinone, 2,5-di-tert-butylhydroquinone, 2,6-di-tert-butylhydroquinone, 2,6-dimethylhydroquinone, 2,3,5-trimethylhydroquinone, benzoquinone, 2,3,5,6-tetrachloro-1,4-benzoquinone, methylbenzoquinone, 2,6-dimethylbenzoquinone, naphthoquinone, or mixtures of two or more thereof.

Phenothiazines, such as phenothiazine and/or derivatives or combinations thereof, or stable organic radicals, such as galvinoxyl radicals and N-oxyl radicals, are preferably taken into consideration as non-phenolic or anaerobic inhibitors, i.e. inhibitors that are active even without oxygen, in contrast with the phenolic inhibitors.

Examples of N-oxyl radicals that can be used are those described in DE 199 56 509. Suitable stable N-oxyl radicals (nitroxyl radicals) can be selected from 1-oxyl-2,2,6,6-tetramethylpiperidine, 1-oxyl-2,2,6,6-tetramethylpiperidin-4-ol (also referred to as TEMPOL), 1-oxyl-2,2,6,6-tetramethylpiperidin-4-one (also referred to as TEMPON), 1-oxyl-2,2,6,6-tetramethyl-4-carboxy-piperdine (also known as 4-carboxy-TEMPO), 1-oxyl-2,2,5,5-tetramethylpyrrolidine, 1-oxyl-2,2,5,5-tetramethyl-3-carboxylpyrrolidine (also referred to as 3-carboxy-PROXYL), aluminum-N-nitrosophenylhydroxylamine and diethylhydroxylamine. Further suitable N-oxyl compounds are oximes, such as acetaldoxime, acetone oxime, methyl ethyl ketoxime, salicyloxime, benzoxime, glyoximes, dimethylglyoxime, acetone-O-(benzyloxycarbonyl)oxime and the like.

These compounds are particularly useful and mostly necessary because otherwise the desired storage stability of preferably more than 3 months, in particular 6 months or more, cannot be achieved. The UV stability and in particular the storage stability can be increased considerably in this way.

Furthermore, pyrimidinol or pyridinol compounds substituted in para-position to the hydroxyl group, as described in patent DE 10 2011 077 248 B1, can be used as inhibitors.

Preferred inhibitors are 1-oxyl-2,2,6,6-tetramethylpiperidine (TEMPO) and 1-oxyl-2,2,6,6-tetramethylpiperidin-4-ol (TEMPOL), catechols, particularly preferably tert-butylpyrocatechol and pyrocatechol, BHT and phenothiazine.

The inhibitors can be used either alone or as a combination of two or more thereof, depending on the desired properties of the reaction resin system. The combination of the phenolic and the non-phenolic inhibitors allows a synergistic effect, as is also shown by the setting of a substantially drift-free adjustment of the gel time of the reaction resin composition.

The reaction resin system can contain the inhibitor in an amount of 0.001 to 5 wt. %, preferably 0.01 to 3 wt. %, particularly preferably 0.05 to 1 wt. %, based on the resin component. If a plurality of inhibitors are contained, the amount just mentioned corresponds to the total amount of inhibitors.

Other Added Substances

According to one embodiment, the resin component contains inorganic added substances, such as fillers and/or other additives.

The fillers used are conventional fillers, preferably mineral or mineral-like fillers, such as quartz, glass, sand, quartz sand, quartz powder, porcelain, corundum, ceramics, talc, silica (e.g. fumed silica), silicates, clay, titanium dioxide, chalk, barite, feldspar, basalt, aluminum hydroxide, granite or sandstone, polymeric fillers such as thermosets, hydraulically curable fillers such as gypsum, quicklime or cement (e.g. alumina cement or Portland cement), metals such as aluminum, carbon black, and also wood, mineral or organic fibers, or the like, or mixtures of two or more thereof, which can be added as powder, in the form of granules or in the form of shaped bodies. The fillers may be present in any desired forms, for example as powder or flour, or as shaped bodies, for example in cylindrical, annular, spherical, platelet, rod, saddle or crystal form, or else in fibrous form (fibrillar fillers), and the corresponding particles preferably have a maximum diameter of 10 mm. However, the globular, inert substances (spherical form) have a preferred and more pronounced reinforcing effect.

Fillers are present in the resin component preferably in an amount of 20 to 90, in particular 40 to 80, more particularly 50 to 80 wt. %.

Further conceivable additives are also rheological additives, such as optionally organically after-treated fumed silica, bentonites, alkyl- and methylcelluloses, castor oil derivatives or the like, plasticizers, such as phthalic or sebacic acid esters, stabilizers, antistatic agents, thickeners, flexibilizers, curing catalysts, rheology aids, wetting agents, coloring additives, such as dyes or in particular pigments, for example for different staining of the components for improved control of the mixing thereof, or the like, or mixtures of two or more thereof. Agents for regulating pH, such as inorganic and/or organic acids according to DE102010008971A1, in particular copolymers having acidic groups, for example esters of phosphoric acid, can also be used. Non-reactive diluents (solvents) such as low-alkyl ketones, e.g. acetone, di-low-alkyl low-alkanoyl amides such as dimethylacetamide, low-alkylbenzenes such as xylenes or toluene, phthalic acid esters or paraffins, or water can also be present, preferably in an amount of up to 30 wt. %, based on the particular component (reaction resin mortar, curing agent), for example from 1 to 20 wt. %. Furthermore, agents for improving the compatibility between the resin component and the hardener component can also be used, such as ionic, nonionic or amphoteric surfactants; soaps, wetting agents, detergents; polyalkylene glycol ethers; salts of fatty acids, mono- or diglycerides of fatty acids, sugar glycerides, lecithin; alkanesulfonates, alkylbenzenesulfonates, fatty alcohol sulfates, fatty alcohol polyglycol ethers, fatty alcohol ether sulfates, sulfonated fatty acid methyl esters; fatty alcohol carboxylates; alkyl polyglycosides, sorbitan esters, N-methyl glucamides, sucrose esters; alkyl phenols, alkyl phenol polyglycol ethers, alkyl phenol carboxylates; quaternary ammonium compounds, esterquats, carboxylates of quaternary ammonium compounds.

In one embodiment of the invention, in addition to the radically curable compound provided, the resin component also contains a hydraulically setting or polycondensable inorganic compound, in particular cement. Such hybrid mortar systems are described in detail in DE 4231161 A1. In this case, the resin component preferably contains, as a hydraulically setting or polycondensable inorganic compound, cement, for example Portland cement or aluminate cement, with cements which are free of transition metal oxide or have a low level of transition metal being particularly preferred. Gypsum can also be used as a hydraulically setting inorganic compound as such or in a mixture with the cement. The resin component may also comprise silicatic, polycondensable compounds, in particular soluble, dissolved and/or amorphous-silica-containing substances such as fumed silica, as the polycondensable inorganic compound.

The reaction resin system can contain the hydraulically setting or polycondensable compound in an amount of 0 to 40 wt. %, preferably 5 to 30 wt. %, particularly preferably 10 to 30 wt. %, based on the resin component. If the reaction system contains hydraulically setting or polycondensable compounds, the total amount of fillers is in the above-mentioned range. Accordingly, the total amount of fillers, including the hydraulically setting and polycondensable compounds, is 20 to 90, in particular 40 to 80, more particularly 50 to 80 wt. %, based on the resin component.

### PREFERRED EMBODIMENTS

In the embodiments described below, the quantities (wt. %) in each case relate to the individual components, i.e. the resin component and the hardener component, unless otherwise stated. The actual amounts are such that the wt. % of the particular component add up to 100.

In a first preferred embodiment of the hardener composition according to the invention, said composition contains:
at least one peroxide as a hardener,
water, and
a filler mixture consisting of a first filler FS1 having a first average particle size d_{50,1} of between 16 and 130 μm and a second filler FS2 having a second average particle size d_{50,2} of between 0.16 and 16 μm, wherein the ratio d_{50,1} to d_{50,2} (d_{50,1}:d_{50,2}) is in the range of 8:1 to 100:1.

In a preferred aspect of this first embodiment, the peroxide is solid and suspended in the water.

In a second preferred embodiment of the hardener composition according to the invention, said composition contains:
at least one peroxide as a hardener.
water, and
a filler mixture consisting of a first filler FS1 having a first average particle size d_{50,1} of between 16 and 130 μm and a second filler FS2 having a second average particle size d_{50,2} of between 0.16 and 16 μm,
wherein the ratio d_{50,1} to d_{50,2} (d_{50,1}:d_{50,2}) is in the range of 8:1 to 100:1, and wherein the fillers are selected from the group consisting of metal oxides, semi-metal oxides, metal hydroxides, metal salts, mineral or mineral-like fillers, hydraulically curable fillers, metals, carbon black and polymeric fillers, preferably metal oxides, metal hydroxides and metal salts.

In a preferred aspect of this second embodiment, the peroxide is solid and suspended in the water.

In a third preferred embodiment of the hardener composition according to the invention, said composition contains:
at least one solid peroxide as a hardener,
water,
a filler mixture consisting of a first filler FS1 having a first average particle size d_{50,1} of between 16 and 130 μm and a second filler FS2 having a second average particle size d_{50,2} of between 0.16 and 16 μm,
wherein the ratio d_{50,1} to d_{50,2} (d_{50,1}:d_{50,2}) is in the range of 8:1 to 100:1, and the fillers are selected from the group consisting of metal oxides, metal hydroxides and metal salts, and
inorganic and/or organic additives.

In a preferred aspect of this third embodiment, the peroxide is suspended in the water.

In a fourth preferred embodiment of the hardener composition according to the invention, said composition contains:
a solid peroxide as a hardener,
water,
a filler mixture consisting of a first filler FS1 having a first average particle size d_{50,1}, of between 16 and 130 μm and a second filler FS2 having a second average particle size d_{50,2} of between 0.16 and 16 μm,
wherein the ratio d_{50,1} to d_{50,2} (d_{50,1}:d_{50,2}) is in the range of 8:1 to 100:1, and the fillers are selected from the group consisting of metal oxides, metal hydroxides and metal salts, and the volume ratio of first filler to second filler (V_{FS1}:V_{FS2}) is in the range of 1.5:1 to 15:1, preferably 2:1 to 10:1, and more preferably 2.5:1 to 5:1, and
inorganic and/or organic additives.

In a preferred aspect of this fourth embodiment, the peroxide is suspended in the water.

In a fifth preferred embodiment of the hardener composition according to the invention, said composition contains:
a solid peroxide,
water,
a filler mixture consisting of a first filler FS1 having a first average particle size d_{50,1} of between 16 and 130 μm and a second filler FS2 having a second average particle size d_{50,2} of between 0.16 and 16 μm,
wherein
   the ratio d_{50,1} to d_{50,2} (d_{50,1}:d_{50,2}) is in the range of 8:1 to 100:1,
   the fillers are selected from the group consisting of metal oxides, metal hydroxides and metal salts,
   the volume ratio of first filler to second filler (V_{FS1}:V_{FS2}) is in the range of 2.5:1 to 5:1,
   the limit filling level is between 55 and 75 vol. %, and
inorganic and/or organic additives.

In a preferred aspect of this fifth embodiment, the peroxide is suspended in the water.

The hardener composition according to the invention is particularly suitable as a hardener component for a two-component reaction resin system for chemical fastening comprising a resin component and a hardener component. Preferred embodiments of such a two-component reaction resin system are described below.

In a preferred first embodiment of a reaction resin system, the resin component contains:
at least one radically curable, ethylenically unsaturated compound and
at least one inorganic filler,

and the hardener component contains:
at least one peroxide as a hardener,
water, and
a filler mixture consisting of a first filler FS1 having a first average particle size d_{50,1} of between 16 and 130 μm and a second filler FS2 having a second average particle size d_{50,2} of between 0.16 and 16 μm, wherein the ratio d_{50,1} to d_{50,2} (d_{50,1}:d_{50,2}) is in the range of 8:1 to 100:1.

In a preferred aspect of this first embodiment of a reaction resin system, the peroxide is suspended in the water. In a further preferred aspect of this first embodiment of a reaction resin system, the resin component contains:
10 to 99.99 wt. %, preferably 15 to 97 wt. %, particularly preferably 30 to 95 wt. %, of the at least one radically curable compound, and
0.01 to 90 wt. %, preferably 3 to 85 wt. %, particularly preferably 5 to 70 wt. %, of the at least one inorganic filler,

and the hardener component contains:
the first filler FS1 first filler FS1 having a first average particle size d_{50,1}, and the second filler FS2 having a second average particle size d_{50,2} in a volume ratio of first filler to second filler (V_{FS1}:V_{FS2}) in the range of 1.5:1 to 15:1,
0.25 to 5 wt. %, preferably 1 to 30 wt. %, particularly preferably 5 to 25 wt. %, of the at least one peroxide, and
10 to 30 wt. %, preferably 10 to 25 wt. %, particularly preferably 15 to 25 wt. %, of water.

In a further, second preferred embodiment of the reaction resin system, the resin component contains:
as a radically curable compound, a reaction resin mixture consisting of at least one reaction resin and a reactive diluent,
at least one inorganic filler,
at least one accelerator, and
at least one inhibitor,

and the hardener component contains:
at least one peroxide as a hardener.
water, and
a filler mixture consisting of a first filler FS1 having a first average particle size d_{50,1} of between 16 and 130 μm and a second filler FS2 having a second average particle size d_{50,2} of between 0.16 and 16 μm, wherein the ratio d_{50,1} to d_{50,2} (d_{50,1}:d_{50,2}) is in the range of 8:1 to 100:1.

In a preferred aspect of this second embodiment of the reaction resin system, the peroxide is suspended in the water. In a further preferred aspect of this second embodiment of the reaction resin system, the resin component contains:
as a radically curable compound, 10 to 99.99 wt. %, preferably 15 to 97 wt. %, particularly preferably 30 to 95 wt. %, of a mixture, namely the reaction resin mixture, consisting of 0 to 100 wt. %, preferably 30 to 70 wt. %, based on the total weight of the mixture, of the at least one reactive resin, and 100 to 0 wt. %, preferably 70 to 30 wt. %, based on the total weight of the mixture, of the at least one reactive diluent, and
0.01 to 15 wt. %, preferably 0.1 to 10 wt. %, particularly preferably 1 to 7 wt. %, of the at least one inorganic filler,
0.01 to 10 wt. %, preferably 0.5 to 5 wt. %, more preferably 1 to 3 wt. %, of the at least one accelerator, and
0.001 to 5 wt. %, preferably 0.01 to 3 wt. %, more preferably 0.1 to 1 wt. %, of the at least one inhibitor,

and the hardener component contains:
the first filler FS1 first filler FS1 having a first average particle size d_{50,1}, and the second filler FS2 having a first average particle size d_{50,2} in a volume ratio of first filler to second filler (V_{FS1}:V_{FS2}) in the range of 1.5:1 to 15:1,
0.25 to 5 wt. %, preferably 1 to 30 wt. %, particularly preferably 5 to 25 wt. %, of the at least one peroxide, and
10 to 30 wt. %, preferably 10 to 25 wt. %, particularly preferably 15 to 25 wt. %, of water.

In a particularly preferred third embodiment of the reaction resin system, the resin component contains:
as a radically curable compound, a reaction resin mixture consisting of at least one reaction resin based on urethane (meth)acrylate and at least one reactive diluent based on (meth)acrylate,
at least one inorganic filler, in particular a silica,
at least one accelerator, and
at least one inhibitor,

and the hardener component contains:
at least one peroxide, in particular a diacyl peroxide,
water,
a filler mixture consisting of a first filler FS1 having a first average particle size d_{50,1}, of between 16 and 130 μm and a second filler FS2 having a second average particle size d_{50,2} of between 0.16 and 16 μm, wherein the ratio d_{50,1} to d_{50,2} (d_{50,1}:d_{50,2}) is in the range of 8:1 to 100:1, and
further inorganic and/or organic additives.

In a preferred aspect of this third embodiment of the reaction resin system, the peroxide is suspended in the water. In a further preferred aspect of this third embodiment of the reaction resin system, the reaction resin system contains the constituents in the amounts specified in the second aspect.

In a very particularly preferred fourth embodiment, the resin component contains:
as a radically curable compound, a reaction resin mixture consisting of at least one reaction resin based on urethane (meth)acrylate and at least one reactive diluent based on (meth)acrylate,
at least one inorganic filler, in particular pyrogenic silica,
at least one hydraulically setting or polycondensable compound, in particular cement,
at least one accelerator, and
at least one inhibitor,

and the hardener component contains:
at least one peroxide, in particular dibenzoyl peroxide,
water,
a filler mixture consisting of a first filler FS1 having a first average particle size d_{50,1} of between 16 and 130 μm and a second filler FS2 having a second average particle size d_{50,2} of between 0.16 and 16 μm, wherein the ratio d_{50,1} to d_{50,2} (d_{50,1}:d_{50,2}) is in the range of 8:1 to 100:1, and
further inorganic and/or organic additives.

In a preferred aspect of this fourth embodiment of the reaction resin system, the peroxide is suspended in the water. In a further, preferred aspect of this fourth embodiment of the reaction resin system, the resin component contains:
as a radically curable compound, 10 to 99.99 wt. %, preferably 15 to 97 wt. %, particularly preferably 30 to 95 wt. %, of a mixture, namely the reaction resin mixture, consisting of 0 to 100 wt. %, preferably 30 to 70 wt. %, based on the total weight of the mixture, of the at least one reactive resin, and 100 to 0 wt. %, preferably 70 to 30 wt. %, based on the total weight of the mixture, of the at least one reactive diluent, and
0.01 to 15 wt. %, preferably 0.1 to 10 wt. %, particularly preferably 1 to 7 wt. %, of the at least one inorganic filler,
0 to 40 wt. %, preferably 5 to 30 wt. %, of the hydraulically setting or polycondensable compound, wherein the total amount of fillers, including the hydraulically setting or polycondensable compound, is 20 to 90 wt. %, preferably 40 to 80 wt. %, particularly preferably 50 to 80 wt. %, based on the resin components,
0.01 to 10 wt. %, preferably 0.5 to 5 wt. %, more preferably 1 to 3 wt. %, of the at least one accelerator, and
0.001 to 5 wt. %, preferably 0.01 to 3 wt. %, more preferably 0.1 to 1 wt. %, of the at least one inhibitor,

and the hardener component contains:
the first filler FS1 first filler FS1 having a first average particle size d_{50,1} and the second filler FS2 having a first average particle size d_{50,2} in a volume ratio of first filler to second filler (V_{FS1}:V_{FS2}) in the range of 1.5:1 to 15:1,
0.25 to 5 wt. %, preferably 1 to 30 wt. %, particularly preferably 5 to 25 wt. %, of the at least one peroxide, and
10 to 30 wt. %, preferably 10 to 25 wt. %, particularly preferably 15 to 25 wt. %, of water.

### EXAMPLES

List of the Constituents Used in the Examples and References (Explanation of Abbreviations) as Well as their Trade Names and Sources of Supply:

| Raw material | Comment | | | Company |
|---|---|---|---|---|
| Perkadox ® L-W40 | dibenzoyl peroxide 40%, suspension in water | | | Akzo Nobel Chemicals B.V. |
| | (CAS number 94-36-0) | | | |
| BP-40-SAQ | dibenzoyl peroxide 40%, suspension in water, | | | United initiators |
| | unbuffered (CAS number 94-36-0) | | | |
| Luperox® EZ-FLO | dibenzoyi peroxide approx. 40%; suspension | | | Arkema |
| | in water (CAS number 94-36-0) | | | |
| Benox ® B-50 | dibenzoyl peroxide 50% in benzoate | | | United Initiators |
| | (CAS number 94-36-0) | | | |
| Peroxan BP-40 WS | dibenzoyl peroxide approx. 40%; suspension | | | Pergan |
| | in water (CAS number 94-36-0) | | | |
| Trigonox ® C | tert-butyl peroxy benzoate (99%, liquid), | | | Akzo Nobel Functional |
| | (CAS number 614-45-9) | | | Chemicals LLC |
| LP-40-SAQ | dilauroyl peroxide 40%, suspension in water | | | United Initiators |
| | (CAS number 105-74-8) | | | |
| Water | deionized | | | |
| Diethyl adipate | | | | Sigma-Aldrich |
| Potassium dihydrogen | water-free | | | Sigma-Aldrich |
| phosphate | | | | |
| Disodium hydrogen citrate | water-free | | | Sigma-Aldrich |
| Glycerol | | | | Sigma-Aldrich |
| Aerosil ® 200 | hydrophilic fumed silica; (CAS number: | | | Evonik |
| | 112945-52-5; spec, surface area 200 m²/g; | | | |
| | average particle size 0.2-0.3 μm | | | |
| | (aggregates)) | | | |
| CAB-O-SIL ® TS720 | hydrophobic PDMS-coated fumed silica | | | Cabot |
| OPTIGEL-CK | activated phyllosilicate (bentonite): (spec, | | | BYK-Chemie GmbH |
| | density 2.6 g/cm³, bulk density 550- | | | |
| | 750 kg/m³, moisture content 10% ± 2%) | | | |
| Axiiat RH23 | xanthan gum; viscosity (1% sol. in 1% KCL | | | Synthomer |
| | (Brookfield LVT HI/60 rpm) 1200-1800 mPas; | | | |
| | pH 6-8; fine powder (CAS number) | | | |
| Sodium hydroxide | | | | Sigma-Aldrich |
| Sodium benzenesulfonate | | | | TCI Europe |
| | | spec, | | |
| | d50 | weight | | |
| Filler | [μm] | [g/cm³] ¹⁾ | Main constituent | Company |
| OMYACARB ® 130AL | 130 | 2.6 | calcium carbonate | Omya GmbH |
| MILLISIL ® W3 | 90 | 2.65 | quartz sand | Quarzwerke GmbH |
| Apyral ® 1E | 50 | 2.4 | aluminum hydroxide | Nabaltec AG |
| MILLISIL ® W6 | 40 | 2.65 | quartz sand | Quarzwerke GmbH |
| OMYACARB ® 40AL | 31 | 2.6 | calcium carbonate | Omya GmbH |
| MILLISIL ® W12 | 16 | 2.65 | quartz sand | Quarzwerke GmbH |
| Corundum 800 | 6.5 | 3.9 | aluminum oxide | Cerablast GmbH & Co |
| | | | | KG |
| Durcal 5 | 6 | 3.6 | calcium carbonate | Omya GmbH |
| Albawhite 40 | 5 | 4.4 | white spar | Sachtleben Minerals |
| | | | | GmbH & Co. KG |
| OMYACARB ® 2AL | 3.2 | 2.6 | calcium carbonate | Omya GmbH |
| Albawhite 70 | 3 | 4.4 | white spar | Sachtleben Minerals |
| | | | | GmbH & Co. KG |
| KaMin 80 | 2.3 | 2.6 | kaolin | KaMin Performance |
| | | | | Minerals |
| Albawhite 80 | 2 | 4.4 | white spar | Sachtleben Minerals |
| | | | | GmbH & Co. KG |
| SF800 | 2 | 2.65 | quartz, | Quarzwerke GmbH |
| | | | fine powder | |
| Albawhite 90 | 1.2 | 4.4 | white spar | Sachtleben Minerals |
| | | | | GmbH & Co. KG |
| Apyral ® 60CD | 1 | 2.4 | aluminum hydroxide | Nabaltec. AG |
| BLANC FIXE ® F | 1 | 4.4 | synthetic barium | Solvay & CPC GmbH & |
| | | | sulfate | Co KG |
| RG4000 | 0.6 | 3.9 | monomodal alpha | Almatis B.V. |
| | | | aluminum oxide | |
| SILMIKRON ® 795-10/1 | 0.5 | 2.65 | quartz, ultra-fine | Quarzwerke GmbH |
| | | | powder | |
| VP1171-850 | 0.3 | 2 | fused silica | Quarzwerke GmbH |
| SACHTOPERSE ® HU-N | 0.04 | 4.4 | synthetic barium | Sachtleben Minerals |
| | | | sulfate | GmbH & Co. KG |

¹⁾ DIN EN ISO 787-10

To demonstrate the influence of the filler mixture according to the invention on the ejection forces of a hardener composition containing said mixture, the hardener compositions described below were prepared and their ejection forces were measured.

The example formulations using different fillers demonstrate that the effect is dependent on the particle size of the raw materials used.

It is within the knowledge and ability of a person skilled in the art formulating compositions according to the invention to eliminate chemical interactions between the individual constituents, such as with the use of acid-labile carbonates at pH values below 7.

Measurement of Ejection Forces

To determine the ejection forces of the hardener compositions, the compositions were placed, without bubbles, in plastic beakers at a height of 90 mm, the beakers having an inner diameter of 40 mm and a height of 100 mm, and were brought to the measuring temperature of 23° C. overnight.

Using a universal testing machine from Zwick-Roell (measuring range 5 kN), a perforated disc comprising conical holes (diameter 35 mm; Art. no. 130654) from Anton Paar was pressed 50 mm deep into the compound at a speed of 3 mm/sec, and the force was determined at a measuring depth of 35 mm.

The ejection forces of the hardener compositions according to the invention and of the comparative hardener compositions were measured at 23° C.

Determination of Influence of Total Filling Level

To demonstrate the influence of the total filling level of a hardener composition for resin components based on radically curable compounds on the ejection forces, hardener compositions were prepared in which the total filling level was increased by adding a further filler. The basic filling level, which indicates the content of solid peroxide and other solids before the addition of fillers FS1 and FS2, must also be taken into account when determining this influence.

For this purpose, a premixture V1 consisting of 48 wt. % of a 40% aqueous dibenzoyl peroxide dispersion (LUPEROX® EZ-FLO; Arkema Inc.), 42.7 wt. % of water, 5.8 wt. % of sodium hydrogen citrate (Na₂H citrate, Sigma Aldrich) and 3.5 wt. % of a rheological additive based on an activated phyllosilicate (OPTIGEL-CK; BYK-Chemie GmbH) was first prepared. To this end, the sodium hydrogen citrate was dissolved in the water and added to the peroxide dispersion. After the phyllosilicate was added, the mixture was stirred briefly by hand using a spatula, and the premixture was sheared in a dissolver (1L, PC Laborsystem; dissolver disc 3.5 cm) for 10 minutes at a speed of 3,500 rpm.

Premixture V2 was prepared in a similar way, by mixing 87 wt. % of BP 40SAQ with 10.14 wt. % of water, 0.75 wt. % of potassium dihydrogen phosphate, 0.11 wt. % of sodium hydroxide and 2 wt. % of OPTIGEL-CK.

These premixtures were then each mixed by hand using a wooden spatula in a total amount of approx. 400 g with the fillers and quantity ratios specified in Table 1 and incorporated again in the dissolver as described above.

The ejection forces of the hardener compositions obtained in each case were measured after heating to 23° C. overnight. The results of the measurements are shown in Table 2.

Determination of the Limit Filling Level

To determine the limit filling level, the maximum filling level was first determined by gradually increasing the maximum amount of first filler FS1, starting from a filling level of 52 vol. %, the proportion of first filler FS1 such that the filling level of the hardener composition is increased by 2 vol. % each time. The ejection force was measured after each addition. Filler FS1 was added until the ejection force tripled for the first time. The increase in the ejection force was calculated from the ratio of the ejection force of a mixture having a given vol. % of filler FS 1 (x vol. % FS 1) to the ejection force of the mixture having 2 vol. % less filler FS 1 (x−2 vol. % FS 1). The results are shown in Table 3.

The comparative hardener compositions were filled with the particular filler FS1 until the maximum filling level was reached and beyond.

Tables 2 and 3 show that, for example, when Millisil® W12 is added as filler FS1, its maximum filling level is approx. 58 vol. %. By comparison, the maximum filling level for Millisil® W3 as filler FS1 is approx. 64 vol. %.

As stated above, the limit filling level is approx. 5 vol. % below the determined maximum filling level of FS1 at 58 vol. %-5 vol. %=53 vol. % for Millisil® W12 and at 59 vol. % for Millisil® W3.

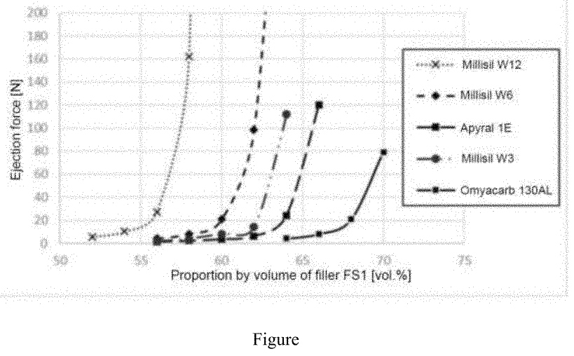

FIG. 1 shows the dependency relationship between the ejection force and the proportion by volume of filler FS1, as can be seen from Table 2. It is clear from the curves that the proportion by volume is dependent on the filler used and must be determined individually for each filler.

The following list shows the example calculation of the filling level in vol. %.

| | Mass | Mass | | Volume = | Vol. | Solid |
|---|---|---|---|---|---|---|
| | proportion | proportion | Density | mass/density | % | (vol. %) |
| Benzoyl peroxide 40% | 25 | | | | | |
| Benzoyl peroxide | | 10 | 1.3 | 7.7 | 15.1 | 15.1 |
| Water | 5 | 20 | 1 | 20.0 | 39.1 | |
| Filler FS1 | 50 | 50 | 2.65 | 18.9 | 36.9 | 36.9 |
| e.g. quartz | | | | | | |
| Filler FS2 | 20 | 20 | 4.4 | 4.5 | 8.9 | 8.9 |
| e.g. barite | | | | | | |
| | 100 | 100 | | 51.1 | 100 | 60.9 |

Substances that are liquid and already contained in the peroxide dispersions are included in the aqueous proportion and may not be explicitly listed here or in the following examples. Thickeners and dissolved salts are not taken into account.

TABLE 1
Weights of filler FS1 in g per 100 g premixture

| | | Filling level in vol. %*) | | | | | | | | | |
|---|---|---|---|---|---|---|---|---|---|---|---|
| | | 52 | 54 | 56 | 58 | 60 | 62 | 64 | 66 | 68 | 70 |
| FS1 | Premixture | Weight of filler FS1 [g] | | | | | | | | | |
| Millisil ® W12 | V1 | 83 | 91.5 | 101 | 111 | 122.5 | | | | | |
| Millisil ® W6 | V1 | | | 101 | 111 | 122.5 | 135 | 149 | | | |
| Apyral 1E | V1 | | 82.9 | 91.5 | 100.5 | 110.9 | 122.3 | 134.9 | | | |
| Millisil ® W3 | V1 | | | 101 | 111 | 122.5 | 135 | 149 | | | |
| Omyacarb ® 130AL | V2 | | | | | | | 98 | 102.2 | 106.5 | 110.5 |

*)contains solid peroxide and filler FS1

TABLE 2
Results of the measurement of the ejection forces of the mixtures from Table 1

| | | Filling level in vol. % | | | | | | | | | |
|---|---|---|---|---|---|---|---|---|---|---|---|
| | | 52 | 54 | 56 | 58 | 60 | 62 | 64 | 66 | 68 | 70 |
| | Premixture | Ejection force [N] | | | | | | | | | |
| Millisil ® W12 | V1 | 5.4 | 10.3 | 27.3 | 161.8 | 1481.2 | | | | | |
| Millisil ® W6 | V1 | | | 4.2 | 8.1 | 20.8 | 98.7 | 458 | | | |
| Apyral 1E | V1 | | | 1.5 | 2.2 | 3.6 | 6.2 | 24 | 120 | | |
| Millisil ® W3 | V1 | | | 1.7 | 4 | 8.3 | 14 | 112.2 | | | |
| Omyacarb 130AL | V2 | | | | | | | 4.2 | 8.1 | 20.8 | 79 |

*)contains solid peroxide and filler FS1

TABLE 3
Ratios of the ejection forces from Table 2

| | | Filling level in vol. % | | | | | | | | | |
|---|---|---|---|---|---|---|---|---|---|---|---|
| | Pre- | 52 | 54 | 56 | 58 | 60 | 62 | 64 | 66 | 68 | 70 |
| | mixture | Ejection force ratio (from Table 2) | | | | | | | | | |
| Millisil ® W12 | V1 | | 1.9 | 2.7 | 5.9 | 9.2 | | | | | |
| Millisil ® W6 | V1 | | | | 1.9 | 2.6 | 4.8 | 4.6 | | | |
| Apyral 1E | V1 | | | | 1.4 | 1.7 | 1.7 | 3.9 | 5.0 | | |
| Millisil ® W3 | V1 | | | | 2.4 | 2.1 | 1.7 | 8.0 | | | |
| Omyacarb | V2 | | | | | | | | 1.9 | 2.6 | 3.8 |
| 130AL | | | | | | | | | | | |

*)contains solid peroxide and filler FS1

Determination of Influence of Particle Size

To demonstrate the influence of the particle size of the filler of a hardener composition for resin components based on radically curable compounds on the ejection forces, hardener compositions were prepared from premixture 1, in which filler mixtures consisting of a first filler and a second filler were used, with the particle size of the second filler being varied. Furthermore, the amount of filler was increased by adding other further fillers. The fillers used in each case and the corresponding amounts are specified in Table 4. The ejection forces of the hardener compositions obtained in each case were measured after heating to 23° C. overnight. The results of the measurements are shown in Table 4.

In place of premixture 1, other hardener compositions comprising the constituents specified in Table 5 were also used in the amounts also specified in Table 5. Here too, the ejection forces of the hardener compositions obtained in each case were measured after heating to 23° C. overnight. The results of the measurements are shown in Table 5. The mixture of the hardener compositions in the examples shown in Table 5 were prepared in a similar way to premixture 1. When using Axilat RH23 as a rheological additive, the premixture was left to stand overnight in the dissolver before the compound was completed in order to swell the thickener.

TABLE 4
Results of the measurements of the ejection force of the hardener composition according to the
invention and of the comparative hardener compositions as a function of the filling level and particle size

| Mass proportions | | | | | | | | |
|---|---|---|---|---|---|---|---|---|
| [wt. %] | | Comparison 1 | Comparison 2 | Comparison 3 | Comparison 4 | Example 1 | Example 2 | Example 3 |
| Premixture 1 | | 50 | 50 | 50 | 50 | 50 | 50 | 50 |
| Benzoyl peroxide | | 9.6 | 9.6 | 9.6 | 9.6 | 9.6 | 9.6 | 9.6 |
| Water | | 35.75 | 35.75 | 35.75 | 35.75 | 35.75 | 35.75 | 35.75 |
| Filler FS1 | d_{50,1} [μm] | | | | | | | |
| MILLISIL ® W6 | 40 | 110 | 110 | 110 | 110 | 110 | 110 | 110 |
| Filler FS2 | d_{50,2} [μm] | | | | | | | |
| MILLISIL ® W6 | 40 | | 10 | 20 | 30 | | | |
| Blanc Fixe F | 1 | | | | | 16.7 | 33 | 50 |
| d_{50,1}:d_{50,2} | | 1 | 1 | 1 | 1 | 40 | 40 | 40 |
| Filling level *⁾ vol. % | | 57.8 | 59.6 | 61.2 | 62.7 | 59.6 | 61.2 | 62.7 |
| Ejection force [N] | | 4 | 8.6 | 23.1 | 122 | 2.35 | 2 | 2 |

*⁾ sum of fillers FS1 and FS2 as well as the peroxide, if this is a solid. Thickeners and salts are not taken into account.
Results of the measurements of the ejection force of the hardener composition according to the invention
and of the comparative hardener compositions as a function of the filling level and particle size

| Mass proportions | | | | |
|---|---|---|---|---|
| [wt. %] | | Example 4 | Example 5 | Example 6 |
| Premixture 1 | | 50 | 50 | 50 |
| Benzoyl peroxide | | 9.6 | 9.6 | 9.6 |
| Water | | 35.75 | 35.75 | 35.75 |
| Filler FS1 | d_{50,1} [μm] | | | |
| MILLISIL ® W6 | 40 | 110 | 110 | 110 |
| Filler FS2 | d_{50,2} [μm] | | | |
| Albawhite 80 | 2 | 16.7 | 33 | 50 |
| d_{50,1}:d_{50,2} | | 20 | 20 | 20 |
| Filling level [vol. %]* | | 59.6 | 61.2 | 62.7 |
| Ejection force [N] | | 3.15 | 2.75 | 2.8 |

*sum of fillers FS1 and FS2 as well as the peroxide, if this is a solid.

Results of the measurements of the ejection force of the hardener composition according to the invention and of
the comparative hardener compositions of the ejection force as a function of the filling level and particle size

| Mass proportions | | Comparison 5 | Comparison 6 | Comparison 7 | Comparison 8 | Example 7 | Example 8 | Example 9 |
|---|---|---|---|---|---|---|---|---|
| Premixture 1 | | 50 | 50 | 50 | 50 | 50 | 50 | 50 |
| Filler FS1 | d_{50,1} [μm] | | | | | | | |
| MILLISIL ® W6 | 40 | 140 | 110 | 110 | 110 | 110 | 110 | 110 |
| Filler FS2 | d_{50,2} [μm] | | | | | | | |
| Apyral 1E | 50 | | 27.2 | | | | | |
| MILLISIL ® W12 | 16 | | | 30 | | | | |
| Corundum 800 | 6.5 | | | | 44.1 | | | |
| Albawhite 40 | 5 | | | | | 50 | | |
| SF800 | 2 | | | | | | 30 | |
| Albawhite 80 | 2 | | | | | | | 50 |
| d_{50,1}:d_{50,2} | | 1 | 0.8 | 2.5 | 6.2 | 8 | 20 | 20 |
| Filling level *⁾ [vol. %] | | 62.7 | 62.8 | 62.7 | 62.7 | 62.8 | 62.7 | 62.8 |
| Ejection force [N] | | 122 | 43.4 | 367 | 35.8 | 11.2 | 10.9 | 2.8 |

*⁾ sum of filters FS1 and FS2 as well as the peroxide, if this is a solid.
Results of the measurements of the ejection force of the hardener composition according to the invention
and of the comparative hardener compositions as a function of the filling level and particle size

| Mass proportions | | Example 10 | Example 11 | Example 12 | Example 13 | Comparison 9 | Comparison 10 |
|---|---|---|---|---|---|---|---|
| Premixture 1 | | 50 | 50 | 50 | 50 | 50 | 50 |
| Filler FSI | d_{50,1} [μm] | | | | | | |
| MILLISIL ® W6 | 40 | 110 | 110 | 110 | 110 | 110 | 110 |
| Filler FS2 | d_{50,2} [μm] | | | | | | |
| BlancFixe-F | 1 | 50 | | | | | |
| Apyral 60CD | 1 | | 27.2 | | | | |
| RG4000 | 0.6 | | | 44.1 | | | |
| 795-10-1 | 0.5 | | | | 30 | | |
| VP1171 | 0.3 | | | | | 22.6 | |
| Sacht HU-N | 0.04 | | | | | | 50 |
| d_{50,1}:d_{50,2} | | 40 | 40 | 66.7 | 80 | 133.3 | 1000 |
| Filling level *⁾ [vol. %] | | 62.8 | 62.8 | 62.7 | 62.7 | 62.7 | 62.8 |
| Ejection force [N] | | 2 | 3.4 | 2.25 | 9.9 | 56.2 | 28.1 |

*⁾ sum of fillers FS1 and FS2 as well as the peroxide, if this is a solid.

TABLE 5
Results of the measurements of the ejection force of the hardener composition according to the invention and of the
comparative hardener compositions as a function of the filling level and particle size (mass proportions)

| Mass | | Comparison | Comparison | Example | Example | Comparison | Comparison | Example | Example |
|---|---|---|---|---|---|---|---|---|---|
| proportions | | 11 | 12 | 14 | 15 | 13 | 14 | 16 | 17 |
| Peroxide ¹⁾ | | 19 | 19 | 19 | 19 | 18.8 | 18.8 | 18.8 | 18.8 |
| Water | | 34 | 34 | 34 | 34 | 33.6 | 33.6 | 33.6 | 33.6 |
| Phosphate | | 0.4 | 0.4 | 0.4 | 0.4 | 0.4 | 0.4 | 0.4 | 0.4 |
| NaOH | | 0.1 | 0.1 | 0.1 | 0.1 | 0.1 | 0.1 | 0.1 | 0.1 |
| Optigel CK | | 1.1 | 1.1 | 1.1 | 1.1 | 1.1 | 1.1 | 1.1 | 1.1 |
| Filler FS1 | d_{50,1} | | | | | | | | |
| | [μm] | | | | | | | | |
| MILLISIL ® | 16 | 65.5 | 65.5 | 65.5 | 65.5 | | | | |
| W12 | | | | | | | | | |
| MILLISIL ® | 40 | | | | | 67.5 | 67.5 | 67.5 | 67.5 |
| W6 | | | | | | | | | |
| Filler FS2 | d_{50,2} | | | | | | | | |
| | [μm] | | | | | | | | |
| RG4000 | 0.6 | | | | | | | 39.6 | |
| Apyral ® 60CD | 1 | | | 27.2 | | | | | 24.5 |
| Albawhite ® 90 | 1.2 | | | | 49.8 | | | | |
| Omyacarb ® | 3.2 | | 30 | | | | | | |
| 2AL | | | | | | | | | |
| Durcal ® 5 | 6 | | | | | 27 | | | |
| MILLISIL ® | 16 | 30 | | | | | 27 | | |
| W12 | | | | | | | | | |
| d_{50,1}:d_{50,2} | | 1 | 5 | 16 | 13.3 | 6.7 | 2.5 | 66.7 | 40 |
| Filling level *⁾ | | 59.8 | 59.8 | 59.8 | 59.8 | 59.9 | 59.9 | 59.9 | 59.9 |
| [vol. %] | | | | | | | | | |
| Ejection force | | 1990 | 1579 | 26 | 24.8 | 1006 | 855 | 27.8 | 14.7 |
| [N] | | | | | | | | | |

*⁾ sum of fillers FS1 and FS2 as well as the peroxide, if this is a solid;
¹⁾ BP-40-SAQ

Results of the measurements of the ejection force of the hardener composition according to the invention and of
the comparative hardener compositions as a function of the filling level and particle size (mass proportions)

| Mass | | Comparison | Comparison | Comparison | Example | Example | Comparison | Comparison | Example | Example |
|---|---|---|---|---|---|---|---|---|---|---|
| proportions | | 15 | 16 | 17 | 18 | 19 | 18 | 19 | 20 | 21 |
| Peroxide ¹⁾ | | 17.2 | 17.2 | 17.2 | 17.2 | 17.2 | 17.4 | 17.4 | 17.4 | 17.4 |
| Water | | 30.8 | 30.8 | 30.8 | 30.8 | 30.8 | 31 2 | 31.2 | 31.2 | 31.2 |
| Sodium | | 0.4 | 0.4 | 0.4 | 0.4 | 0.4 | 0.4 | 0.4 | 0.4 | 0.4 |
| dihydrogen | | | | | | | | | | |
| phosphate | | | | | | | | | | |
| NaOH | | 0.05 | 0.05 | 0.05 | 0.05 | 0.05 | 0.06 | 0.06 | 0.06 | 0.06 |
| Optigel CK | | 1 | 1 | 1 | 1 | 1 | 1 | 1 | 1 | 1 |
| Filler FS1 | d_{50,1} | | | | | | | | | |
| | [μm] | | | | | | | | | |
| MILLISIL ® | 90 | 71.5 | 71.5 | 71.5 | 71.5 | 71.5 | 90 | 90 | 90 | 90 |
| W3 | | | | | | | | | | |
| Filler FS2 | d_{50,2} | | | | | | | | | |
| | [μm] | | | | | | | | | |
| Sachtoperse | 0.04 | | | 54.8 | | | | | | |
| HU-N | | | | | | | | | | |
| Apyral 60CD | 1 | | | | 30.3 | | | | 27.7 | |
| Omyacarb 2AL | 3.2 | | | | | | | | | 30 |
| Albawhite 70 | 3 | | | | | 54.8 | | | | |
| MILLISIL ® | 16 | 33 | | | | | 30 | | | |
| W12 | | | | | | | | | | |
| Omyacarb 40AL | 31 | | 33 | | | | | | | |
| Apyral 1E | 50 | | | | | | | 27.7 | | |
| d_{50,1}:d_{50,2} | | 5.6 | 2.5 | 2250 | 90 | 30 | 5.6 | 1.3 | 90 | 28.1 |
| Filling level *⁾ | | 63.1 | 63.2 | 63.1 | 63.2 | 63.1 | 63.5 | 63.5 | 63.5 | 63.5 |
| [vol. %] | | | | | | | | | | |
| Ejection force | | 118 | 108 | 419 | 14.6 | 15.3 | 550 | 370 | 13 | 30 |
| [N] | | | | | | | | | | |

*⁾ sum of fillers FS1 and FS2 as well as the peroxide, if this is a solid;
¹⁾ BP-40-SAQ
Results of the measurements of the ejection force of the hardener composition according to the invention and of
the comparative hardener compositions as a function of the filling level and particle size (mass proportions)

| Mass | | Comparison | Comparison | Example | Example | Example | Example | Example | Example | Example |
|---|---|---|---|---|---|---|---|---|---|---|
| proportions | | 20 | 21 | 22 | 23 | 24 | 25 | 26 | 27 | 28 |
| Peroxide ²⁾ | | 20.7 | 20.7 | 20.7 | 20.7 | 20.7 | 20.7 | 20.7 | 20.7 | 20.7 |
| Water | | 36.9 | 36.9 | 36.9 | 36.9 | 36.9 | 36.9 | 36.9 | 36.9 | 36.9 |
| Disodium | | 0.7 | 0.7 | 0.7 | 0.7 | 0.7 | 0.7 | 0.7 | 0.7 | 0.7 |
| hydrogen citrate | | | | | | | | | | |
| Optigel CK | | 1.7 | 1.7 | 1.7 | 1.7 | 1.7 | 1.7 | 1.7 | 1.7 | 1.7 |
| Filler FS1 | d_{50,1} | | | | | | | | | |
| | [μm] | | | | | | | | | |
| MILLISIL ® | 40 | 75 | 75 | 75 | 75 | 75 | 75 | 75 | 75 | 75 |
| W6 | | | | | | | | | | |
| Filler FS2 | d_{50,2} | | | | | | | | | |
| | [μm] | | | | | | | | | |
| VP1171-850 | 0.5 | | | 22.6 | | | | | | |
| RG4000 | 0.6 | | | | 44 | | | | | |
| Apyral 60CD | 1 | | | | | 27.2 | | | | |
| Albawhite 90 | 1.2 | | | | | | 49.8 | | | |
| SF800 | 2 | | | | | | | 30 | | |
| KaMin 80 | 2.3 | | | | | | | | 30 | |
| Albawhite 40 | 5 | | | | | | | | | 49.8 |
| MILLISIL ® | 16 | 30 | | | | | | | | |
| W12 | | | | | | | | | | |
| MILLISIL ® | 40 | | 30 | | | | | | | |
| W6 | | | | | | | | | | |
| d_{50,1}:d_{50,2} | | 2.5 | 1 | 80 | 66.7 | 40 | 33.3 | 20 | 17.4 | 8 |
| Filling level | | 60.1 | 60.1 | 60.1 | 60.1 | 60.1 | 60.1 | 60.1 | 60.1 | 60.1 |
| [vol. %] | | | | | | | | | | |
| Election force | | 1092 | 912 | 10.9 | 3.8 | 4.3 | 3.2 | 4.9 | 2.85 | 6.7 |
| [N] | | | | | | | | | | |

*⁾ sum of fillers FS1 and FS2 as well as the peroxide, if this is a solid;
²⁾ Peroxan BP40W
Results of the measurements of the ejection force of the hardener composition according to the invention and of
the comparative hardener compositions as a function of the filling level and particle size (mass proportions)

| Mass | | Comparison | Comparison | Example | Example | Example | Example | Example |
|---|---|---|---|---|---|---|---|---|
| proportions | | 22 | 23 | 29 | 30 | 31 | 32 | 33 |
| Peroxide ¹⁾ | | 17.6 | 17.6 | 17.6 | 17.6 | 17.6 | 17.6 | 17.6 |
| Water | | 31.4 | 31.4 | 31.4 | 31.4 | 31.4 | 31.4 | 31.4 |
| Citrate | | 0.6 | 0.6 | 0.6 | 0.6 | 0.6 | 0.6 | 0.6 |
| Axilat RH23 | | 0.4 | 0.4 | 0.4 | 0.4 | 0.4 | 0.4 | 0.4 |
| Aerosil 200 | | | | | | | | |
| Filler FS1 | d_{50,1} | | | | | | | |
| | [μm] | | | | | | | |
| MILLISIL ® | 40 | 70 | 70 | 70 | 70 | 70 | 70 | 70 |
| W6 | | | | | | | | |
| Filler FS2 | d_{50,2} | | | | | | | |
| | [μm] | | | | | | | |
| RG4000 | 0.6 | | | 48.4 | | | | |
| Apyral 60CD | 1 | | | | 30.3 | | | |
| KaMin 80 | 2.3 | | | | | 33 | | |
| Albawhite 70 | 3 | | | | | | 54.8 | |
| Albawhite 40 | 5 | | | | | | | 54.8 |
| MILLISIL ® | 16 | 33 | | | | | | |
| W12 | | | | | | | | |
| MILLISIL ® | 40 | | 33 | | | | | |
| W6 | | | | | | | | |
| d_{50,1}:d_{50,2} | | 2.5 | 1 | 66.7 | 40 | 17.4 | 13.3 | 8 |
| Filling level *⁾ | | 62.5 | 62.5 | 62.5 | 62.6 | 62.5 | 62.5 | 62.5 |
| [vol. %] | | | | | | | | |
| Ejection force | | 1000 | 1793 | 4.9 | 4.15 | 25.1 | 10.2 | 16.4 |
| [N] | | | | | | | | |

*⁾ sum of fillers FS1 and FS2 as well as the peroxide, if this is a solid;
¹⁾ BP-40-SAQ
Results of the measurements of the ejection force of the hardener composition according to the invention and of
the comparative hardener compositions as a function of the filling level and particle size (mass proportions)

| Mass | | Comparison | Comparison | Example | Example | Example | Example | Example |
|---|---|---|---|---|---|---|---|---|
| proportions | | 24 | 25 | 34 | 35 | 36 | 37 | 38 |
| Peroxide ³⁾ | | 18 | 18 | 18 | 18 | 18 | 18 | 18 |
| Water | | 31.1 | 31.1 | 31.1 | 31.1 | 31.1 | 31.1 | 31.1 |
| Citrate | | 0.5 | 0.5 | 0.5 | 0.5 | 0.5 | 0.5 | 0.5 |
| Aerosil 200 | | 2 | 2 | 2 | 2 | 2 | 2 | 2 |
| Filler FS1 | d_{50,1} | | | | | | | |
| | [μm] | | | | | | | |
| MILLISIL ® | 40 | 69.9 | 69.9 | 69.9 | 69.9 | 69.9 | 69.9 | 69.9 |
| W6 | | | | | | | | |
| Filler FS2 | d_{50,2} | | | | | | | |
| | [μm] | | | | | | | |
| RG4000 | 0.6 | | | 44 | | | | |
| Apyral 60CD | 1 | | | | 27.2 | | | |
| SF800 | 2 | | | | | 30 | | |
| Albawhite 70 | 3 | | | | | | 49.8 | |
| BlancFixe N | 3 | | | | | | | 49.8 |
| MILLISIL ® | 16 | 30 | | | | | | |
| W12 | | | | | | | | |
| MILLISIL ® | 40 | | 30 | | | | | |
| W6 | | | | | | | | |
| d_{50,1}:d_{50,2} | | 2.5 | 1 | 66.7 | 40 | 20 | 13.3 | 13.3 |
| Filling level *⁾ | | 62.4 | 62.4 | 62.4 | 62.4 | 62.4 | 62.4 | 62.4 |
| [vol. %] | | | | | | | | |
| Ejection force | | 1988 | 134 | 6.5 | 7.1 | 48.4 | 14.4 | 23.6 |
| [N] | | | | | | | | |

*⁾ sum of fillers FS1 and FS2 as well as the peroxide, if this is a solid;
³⁾ Perkadox L-W-40
Results of the measurements of the ejection force of the hardener composition according to the invention and of
the comparative hardener compositions as a function of the filling level and particle size

| Mass | | Comparison | Comparison | Example | Example | Comparison | Example | Example | Example |
|---|---|---|---|---|---|---|---|---|---|
| proportions | | 26 | 27 | 39 | 40 | 28 | 41 | 42 | 43 |
| Peroxide ¹⁾ | | 2.4 | 2.4 | 2.4 | 2.4 | 2.9 | 2.9 | 2.9 | 2.9 |
| Water | | 33.7 | 33.7 | 33.7 | 33.7 | 35.9 | 35.9 | 35.9 | 35.9 |
| Sodium | | 2.2 | 2.2 | 2.2 | 2.2 | 2.4 | 2.4 | 2.4 | 2.4 |
| dihydrogen | | | | | | | | | |
| phosphate | | | | | | | | | |
| Optigel CK | | 1.5 | 1.5 | 1.5 | 1.5 | 1.4 | 1.4 | 1.4 | 1.4 |
| Glycerol | | | | | | 2 | 2 | 2 | 2 |
| Sodium | | | | | | 0.05 | 0.05 | 0.05 | 0.05 |
| benzene- | | | | | | | | | |
| sulfonate | | | | | | | | | |
| Filler FS1 | d_{50,1} | | | | | | | | |
| | [μm] | | | | | | | | |
| MILLISIL ® | 40 | 80.2 | 80.2 | 80.2 | 80.2 | 85 | 85 | 85 | 85 |
| W6 | | | | | | | | | |
| Filler FS2 | d_{50,2} | | | | | | | | |
| | [μm] | | | | | | | | |
| RG4000 | 0.6 | | | 73.6 | | | 58.9 | | |
| Apyral 60CD | 1 | | | | | | | 36.2 | |
| SF800 | 2 | | | | 50 | | | | |
| Albawhite 70 | 3 | | | | | | | | 66.4 |
| MILLISIL ® | 16 | 50 | | | | | | | |
| W12 | | | | | | | | | |
| MILLISIL ® | 40 | | 50 | | | 40 | | | |
| W6 | | | | | | | | | |
| d_{50,1}:d_{50,2} | | 2.5 | 1 | 66.7 | 20 | 1 | 68.7 | 40 | 13.3 |
| Filling level *⁾ | | 60.2 | 60.2 | 60.2 | 60.2 | 56.6 | 56.6 | 56.6 | 56.6 |
| [vol. %] | | | | | | | | | |
| Ejection force | | 980 | 1603 | 68.5 | 13.7 | 1170 | 31 | 8.6 | 19.4 |
| [N] | | | | | | | | | |

*⁾ sum of fillers FS1 and FS2 as well as the peroxide, if this is a solid;
¹⁾ BP-40-SAQ
Results of the measurements of the ejection force of the hardener composition according to the invention and of
the comparative hardener compositions as a function of the filling level and particle size

| Mass | | Comparison | Comparison | Example | Example | Example | Example | Comparison | Example | Example |
|---|---|---|---|---|---|---|---|---|---|---|
| proportions | | 29 | 30 | 44 | 45 | 46 | 47 | 31 | 48 | 49 |
| Peroxide ¹⁾ | | 6.8 | 6.8 | 6.8 | 6.8 | 6.8 | 6.8 | 7.2 | 7.2 | 7.2 |
| Water | | 32.9 | 32.9 | 32.9 | 32.9 | 32.9 | 32.9 | 34.6 | 34.6 | 34.6 |
| Phosphate | | 1.7 | 1.7 | 1.7 | 1.7 | 1.7 | 1.7 | 1.7 | 1.7 | 1.7 |
| Optigei CK | | 1.4 | 1.4 | 1.4 | 1.4 | 1.4 | 1.4 | 1.4 | 1.4 | 1.4 |
| Filler FS1 | d_{50,1} | | | | | | | | | |
| | [μm] | | | | | | | | | |
| MILLISIL ® | 40 | 77.2 | 77.2 | 77.2 | 77.2 | 77.2 | 77.2 | 85 | 85 | 85 |
| W6 | | | | | | | | | | |
| Filler FS2 | d_{50,2} | | | | | | | | | |
| | [μm] | | | | | | | | | |
| RG4000 | 0.6 | | | 59.4 | | | | | | |
| Apyral 60CD | 1 | | | | 36.7 | | | | 36.2 | |
| Albawhite 90 | 1.2 | | | | | 67.2 | | | | |
| SF800 | 2 | | | | | | 40.5 | | | 40 |
| MILLISIL ® | 16 | 40.5 | | | | | | | | |
| W12 | | | | | | | | | | |
| MILLISIL ® | 40 | | 40.5 | | | | | 40 | | |
| W6 | | | | | | | | | | |
| d_{50,1}:d_{50,2} | | 2.5 | 1 | 66.7 | 40 | 33.3 | 20 | 1 | 40 | 20 |
| Filling level *⁾ | | 60.1 | 60.1 | 60.1 | 60.1 | 60.1 | 60.1 | 60.4 | 60.4 | 60.4 |
| [vol. %] | | | | | | | | | | |
| Ejection force | | 1270 | 1542 | 49 | 62.6 | 42.4 | 3.8 | 1030 | 9.4 | 5.4 |
| [N] | | | | | | | | | | |

*⁾ sum of fillers FS1 and FS2 as well as the peroxide, if this is a solid;
¹⁾ BP-40-SAQ
Results of the measurements of the ejection force of the hardener composition according to the invention and of
the comparative hardener compositions as a function of the filling level and particle size

| | | Comparison | Comparison | Example | Comparison | Example |
|---|---|---|---|---|---|---|
| | | 32 | 33 | 50 | 34 | 51 |
| Peroxide | | 17.4 ¹⁾ | 19.4 ⁴⁾ | 19.4 ⁴⁾ | 25 ⁵⁾ | 25 ⁵⁾ |
| Water | | 36.2 | 29.1 | 29.1 | | |
| Benzoate | | | | | 25 | 25 |
| plasticizers | | | | | | |
| Potassium | | 0.77 | | | | |
| dihydrogen | | | | | | |
| phosphate | | | | | | |
| Sodium | | 0.1 | | | | |
| hydroxide | | | | | | |
| Optigel CK | | 1 | | | | |
| Aerosil ® 200 | | | 1.5 | 1.5 | | |
| Filler FS1 | d_{50,1} | | | | | |
| | [μm] | | | | | |
| Millisil® WB | 40 | | | | 30 | 30 |
| Omyacarb | 16 | 90 | | | | |
| 130AL | | | | | | |
| Apyral 1E | 50 | | 85 | 85 | | |
| Filler FS2 | d_{50,2} | | | | | |
| | [μm] | | | | | |
| Apyral 60CD | 0.6 | | | 25 | | |
| Blanc Fixe F | 1.2 | | | | | 16.6 |
| Millisil ® W6 | 40 | | | | 10 | |
| Omyacarb | 16 | 30 | | | | |
| 130AL | | | | | | |
| Apyral IE | 40 | | 25 | | | |
| d_{50,1}:d_{50,2} | | 1 | 1 | 50 | 1 | 40 |
| Filling level *⁾ | | 62.2 | 67.6 | 67.6 | 57.9 | 57.9 |
| [vol. %] | | | | | | |
| Ejection force | | 1570.8 | 30.4 | 18.2 | 54.5 | 28.5 |
| [N] | | | | | | |

*) sum of fillers FS1 and FS2 as well as the peroxide, if this is a solid;
¹⁾ BP-40-SAQ;
⁴⁾ Luperox ® EZ-FLO;
⁵⁾ Benox ® B-50
Results of the measurements of the ejection force of the hardener composition according to the invention and of
the comparative hardener compositions as a function of the filling level and particle size

| | | Comparison | Example | Comparison | Example |
|---|---|---|---|---|---|
| | | 35 | 52 | 36 | 53 |
| Peroxide | | 4 ⁶⁾ | 4 ⁶⁾ | 20 ⁷⁾ | 20 ⁷⁾ |
| Water | | | | 30 | 30 |
| Diethyl adipate | | 46 | 46 | | |
| CAB-O-SIL ® | | 3 | 3 | | |
| TS720 | | | | | |
| Filler FS1 | d_{50,1} | | | | |
| | [μm] | | | | |
| Millisil ® W6 | 40 | 135 | 135 | | |
| Omyacarb | 16 | | | 50 | 50 |
| 130AL | | | | | |
| Filler FS2 | d_{50,2} | | | | |
| | [μm] | | | | |
| Albawhite 80 | 2 | | | | |
| 795-10-1 | 0.5 | | 40 | | 33.2 |
| Millisil ® W6 | 40 | 40 | | 20 | |
| d_{50,1}:d_{50,2} | | 1 | 80 | 1 | 93 |
| Filling level *⁾ | | 56.9 | 56.9 | 56.4 | 56.4 |
| [vol. %] | | | | | |
| Ejection force | | 1812.8 | 48.4 | 157.4 | 10.4 |
| [N] | | | | | |

*⁾ sum of fillers FS1 and FS2 as well as the peroxide, if this is a solid (total filling level);
⁶⁾ Trigonox ® C;
⁷⁾ LP-40-SAQ

It is clear from the results of the measurement of the ejection forces shown in Tables 4 and 5 that by increasing the total filling level from 47.3% (vol/vol) to 53.4% (vol/vol), by adding a second filler selected such that the ratio d_{50,1}:d_{50,2} was 40 or 20, the ejection force was not increased. If the same filling level was set by further addition of the first filler such that the ratio d_{50,1}:d_{50,2} was 1, an increase in the ejection force from 4 N to 122 N was observed.

Furthermore, the results of the measurement of the ejection forces shown in Tables 4 and 5 clearly show that, when using a filler mixture consisting of a first and a second filler, the particle size of the second filler has a significant influence on the ejection forces. If the second filler is selected such that the ratio d_{50,1}:d_{50,2} is between 8 and 100, the ejection forces the measured values barely increase and are approximately 100 N or less. If the second filler is selected such that the ratio d_{50,1}:d_{50,2} is outside the range of 8 to 100, the ejection forces increase significantly and, in some cases, increase tenfold.

1: A hardener composition for a reactive resin system comprising a reactive resin based on radically curable, ethylenically unsaturated compounds, wherein the hardener composition comprises:
a hardener for the reactive resin, and
a filler mixture,
wherein the filler mixture consists of a first filler having a first average particle size d_{50,1} and a second filler having a second average particle size d_{50,2},
wherein the first average particle size d_{50,1} of the first filler is greater than the second average particle size d_{50,2} of the second filler (d_{50,1}>d_{50,2}), and a ratio d_{50,1} to d_{50,2} (d_{50,1}:d_{50,2}) is in a range of approx. 8:1 to approx. 100:1.

2: The hardener composition according to claim 1, wherein the first average particle size d_{50,1} of the first filler is 16 to 130 μm.

3: The hardener composition according to claim 1, wherein the second average particle size d_{50,2} of the second filler is 0.16 to 16 μm.

4: The hardener composition according to claim 1, wherein the first filler and the second filler of the filler mixture are each selected from the group consisting of a metal oxide, a semi-metal oxide, a metal hydroxide, a metal salt, a mineral or mineral-like filler, a hydraulically curable filler, a metal, carbon black, and a polymeric filler.

5: The hardener composition according to claim 4, wherein the first filler is selected from the group consisting of a metal oxide, a metal hydroxide and a metal salt.

6: The hardener composition according to claim 1, wherein a proportion of the first filler is greater than a proportion of the second filler.

7: The hardener composition according to claim 1, wherein the hardener for the reactive resin is based on a radically curable compound.

8: The hardener composition according to claim 1, wherein the hardener composition also contains water.

9: A method, comprising:
mixing a hardener composition into a reactive resin composition for chemical fastening comprising a reactive resin based on radically curable, ethylenically unsaturated compounds,
wherein the hardener composition comprises a filler mixture consisting of a first filler having a first average particle size d_{50,1} and a second filler having a second average particle size d_{50,2},
wherein the first average particle size d_{50,1} of the first filler is greater than the second average particle size d_{50,2} of the second filler (d_{50,1}>d_{50,2}), and a ratio d_{50,1} to d_{50,2} (d_{50,1}:d_{50,2}) is in a range of 8:1 to 100:1.

10: The method according to claim 9, wherein the first average particle size d_{50,1} of the first filler is 16 to 130 μm.

11: The method according to claim 9, wherein the second average particle size d_{50,2} of the second filler is 0.16 to 16 μm.

12: A multi-component reaction resin system, comprising:
a resin component comprising a radically curable, ethylenically unsaturated compound, and
a hardener component comprising the hardener composition according to claim 1.

13: The multi-component reaction resin system according to claim 12, wherein the radically curable, ethylenically unsaturated compound comprises at least one reaction resin, at least one reactive diluent, or a mixture of at least one reaction resin and a reactive diluent.

14: The multi-component reaction resin system according to claim 13, wherein the radically curable, ethylenically unsaturated compound is a compound based on urethane (meth)acrylate, a compound based on epoxy (meth)acrylate, a methacrylate of an alkoxylated bisphenol, or a compound based on other ethylenically unsaturated compounds.

15: The multi-component reaction resin system according to claim 12, wherein the resin component further comprises an inorganic aggregate.

16: The multi-component reaction resin system according to claim 12, wherein the resin component further comprises an inhibitor and/or an accelerator.

17: The multi-component reaction resin system according to claim 12, wherein the multi-component reaction resin system is a two-component system.
